(19) United States
(12) Patent Application Publication
(10) Pub. No.: US 2024/0370140 A1
(43) Pub. Date: Nov. 7, 2024

(54) Devices, Methods, and Graphical User Interfaces for Switching Between Tab Groups in a Browser Application

(71) Applicant: Apple Inc., Cupertino, CA (US)

(72) Inventor: Marco Triverio, San Francisco, CA (US)

(21) Appl. No.: 18/653,797

(22) Filed: May 2, 2024

Related U.S. Application Data
(60) Provisional application No. 63/464,492, filed on May 5, 2023.

(51) Int. Cl. G06F 3/0483; G06F 3/0482

(52) U.S. Cl. CPC G06F 3/0483; G06F 3/0482

(57) ABSTRACT

A method is performed at a computer system that is in communication with a display generation component and one or more input devices. A first set of representations of open pages associated with a first tab group of a plurality of tab groups of a browser application and a plurality of tab group representations corresponding to a subset of the plurality of tab groups are concurrently displayed. While the first set of representations of open pages and the plurality of tab group representations are concurrently displayed, a first input directed to the plurality of tab group representations is detected. In response and in accordance with a determination the first input meets first directional criteria, a second set of representations of open pages associated with a second tab group of the plurality of tab groups is displayed.

### RELATED APPLICATIONS

This application claims priority to U.S. Provisional Patent Application No. 63/464,492, filed May 5, 2023, which is hereby incorporated by reference in its entirety.

### TECHNICAL FIELD

This relates generally to interacting with a browser application on an electronic device that is in communication with a touch-sensitive surface.

### BACKGROUND

Tabbed browsing allows users to open and navigate multiple webpages (sometimes written as “web pages”) at the same time. Some users, however, overfill a browser's tab bar with many open tabs. A tab bar that is cluttered with many open tabs becomes inefficient to navigate. For example, it can be difficult to recall the location, content, and/or order of open tabs, thereby increasing the number of inputs and the amount of time that is necessary to switch between tabs and/or navigate to a particular tab. In addition, it can be even more difficult to open and interact with multiple open tabs when browsing on electronic devices with small touch-sensitive surfaces.

### SUMMARY

Accordingly, there is a need for electronic devices with faster, more efficient methods and interfaces for interacting with tabs in a web browser. Such methods and interfaces optionally complement or replace conventional methods for tabbed browsing. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display generation component and one or more input devices. The method includes while concurrently displaying a first set of representations of open pages associated with a first tab group of a plurality of tab groups of a browser application and a plurality of tab group representations corresponding to a subset of the plurality of tab groups, the subset including at least two of the tab groups, detecting a first input directed to the plurality of tab group representations. The method includes, in response to detecting the first input directed to the plurality of tab group representations: in accordance with a determination the first input meets first directional criteria, displaying a second set of representations of open pages associated with a second tab group of the plurality of tab groups. The first directional criteria require that the first input includes movement in a first direction in order to be met.

In accordance with some embodiments, a method is performed at a computer system that is in communication with a display generation component and one or more input devices. The method includes while displaying a user interface of a browser application, including a tab bar, detecting a first input directed to the tab bar. The method includes, in response to detecting the first input directed to the tab bar, in accordance with a determination that a first plurality of tab group representations are displayed in the tab bar and that the first input meets first directional criteria, displaying a second plurality of tab group representations in the tab bar. The first directional criteria require that the first input includes movement in a first direction in order to be met. The first plurality of tab group representations correspond to a first subset of a plurality of tab groups. The first subset includes at least two of the plurality of tab groups. The second plurality of tab group representations correspond to a second subset of a plurality of tab groups. The second subset including at least two of the tab groups. The method further includes, in response to detecting the first input directed to the tab bar, in accordance with a determination that a first tab representation is displayed in the tab bar and that the first input meets the first directional criteria, displaying a second tab representation in the tab bar. The first tab representation corresponds to a first tab of a plurality of tabs and the second tab representation corresponds to a second tab of the plurality of tabs.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for tabbed browsing, thereby increasing the effectiveness, efficiency, and user satisfaction with such devices. Such methods and interfaces may complement or replace conventional methods for tabbed browsing.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5S illustrate example user interfaces for switching between tab groups in a browser application, in accordance with some embodiments.

FIGS. 6A-6C are flow diagrams of a process for switching between tab groups in a browser application, in accordance with some embodiments.

FIG. 7 is flow diagram of a process for switching between tabs and tab groups in a browser application, in accordance with some embodiments.

### DESCRIPTION OF EMBODIMENTS

Some users overfill a browser's tab bar with many open tabs. A tab bar that is cluttered with many open tabs becomes inefficient to navigate. Tab groups, which enable a user to store related tabs together in a group (herein called a tab groups), are a useful tool for organizing open tabs in electronic device. However, a user may need to access and create many tab groups while browsing. Some methods for navigating tab groups in a browser application require a sequence of multiple user inputs to navigate various controls and menu systems. For example, a user may need to search through multiple menus and/or sub-menus to find a menu that has a menu option for accessing and/or switching to another tab group. Searching for the correct menu option or control can be tedious and time consuming. Additionally, the menus and/or controls clutter the browser application's user interface. The methods and systems described herein allow a user to switch between tab groups using a swipe gesture directed to a tab bar in which tab group representations are displayed. Optionally, the swipe gesture for switching between tab groups is directed to one or more tab group representations. Switching from one tab group to another in response to a swipe gesture reduces the number of inputs and the amount of time necessary to navigate tab groups in the browser application, thereby providing making the user-device interaction more efficient without cluttering the user interface of the browser application with additional controls.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

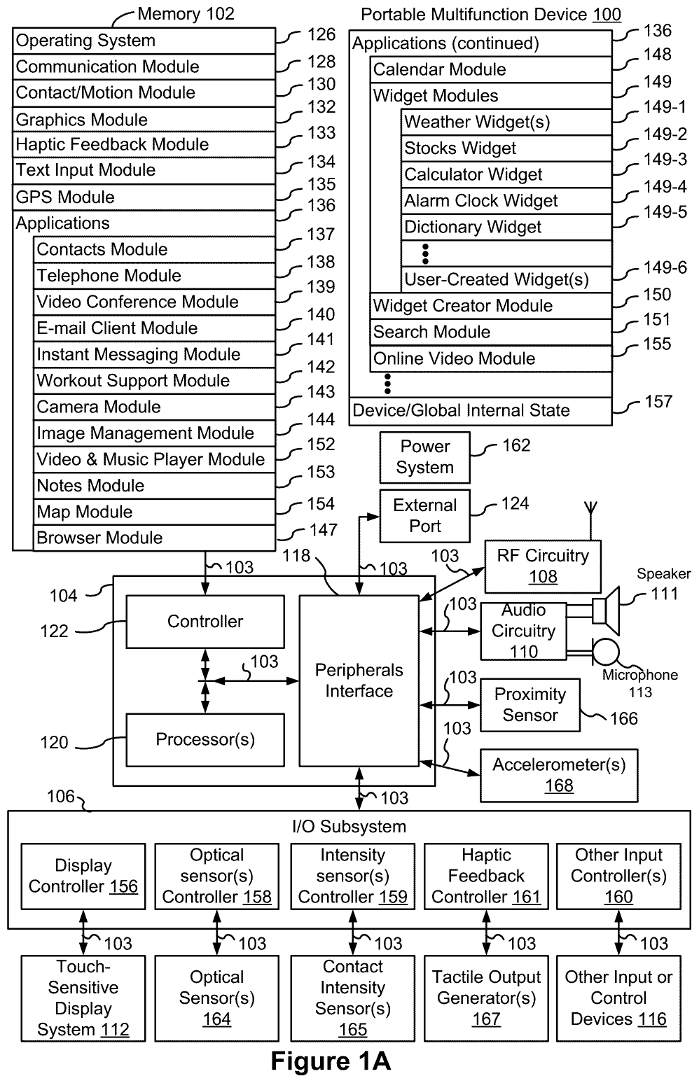

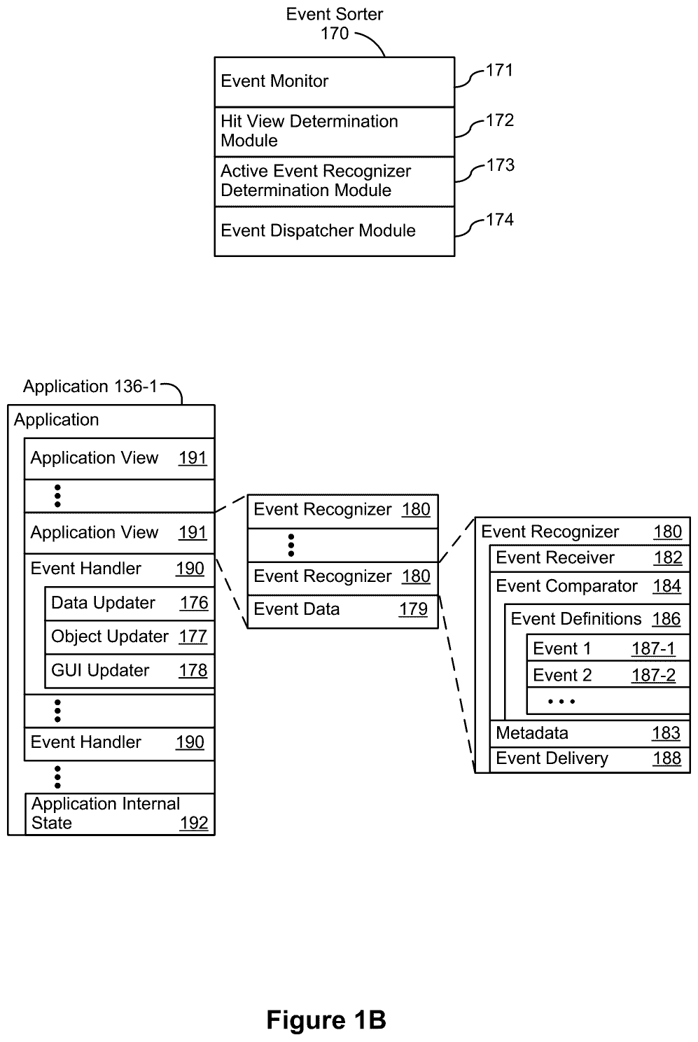

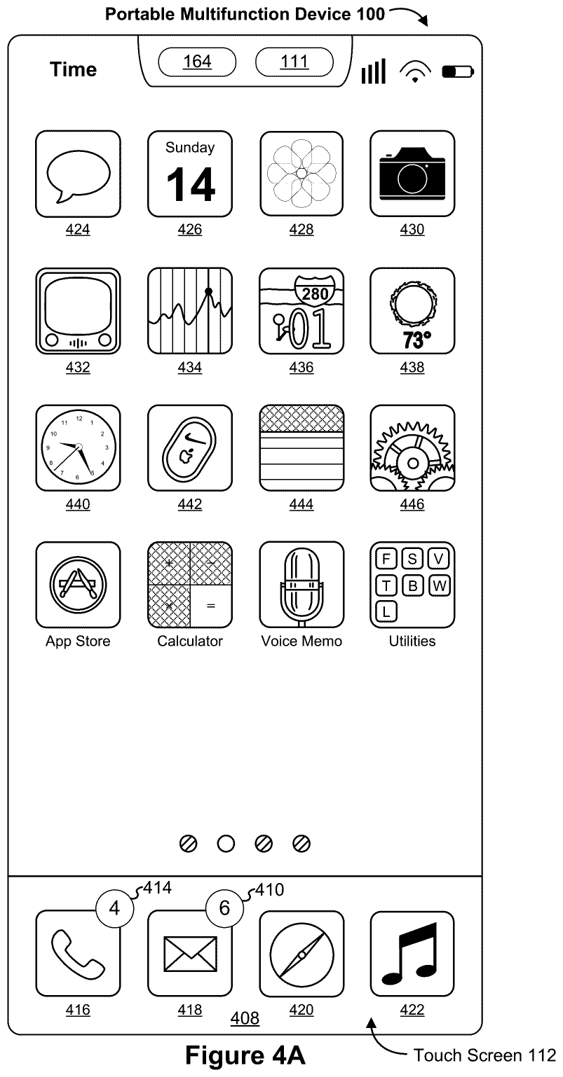

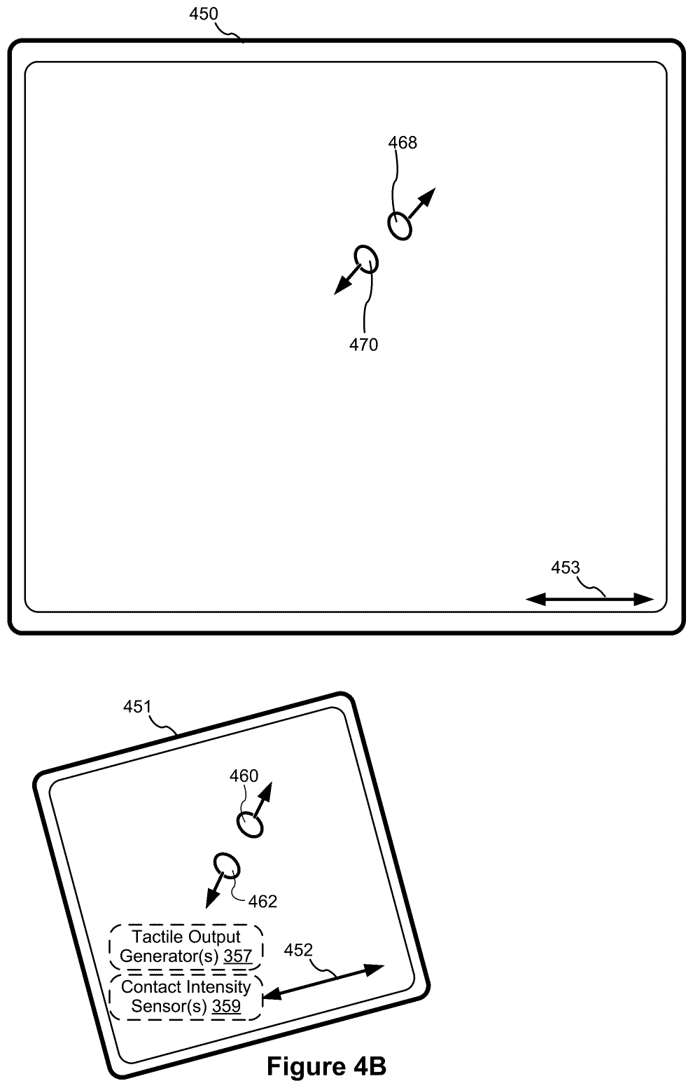

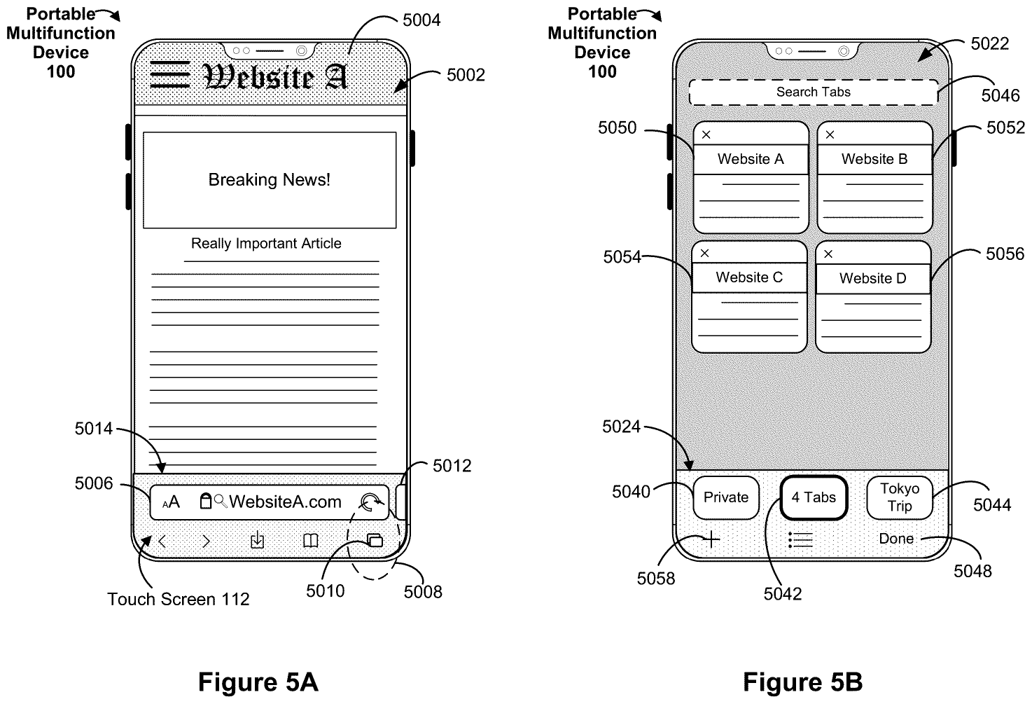

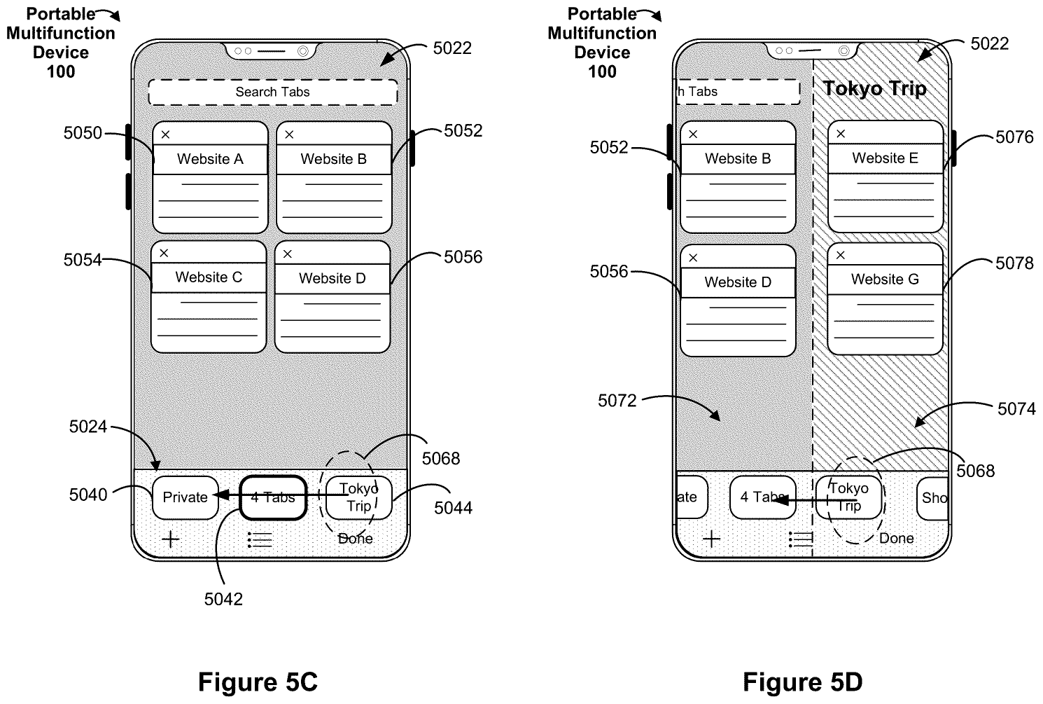

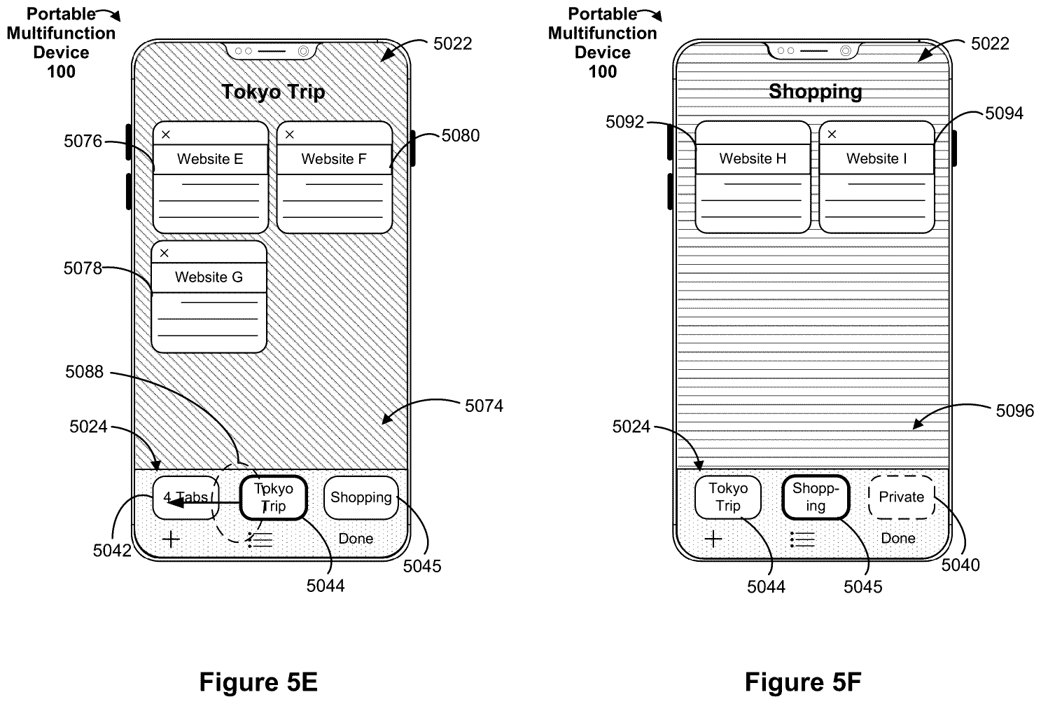

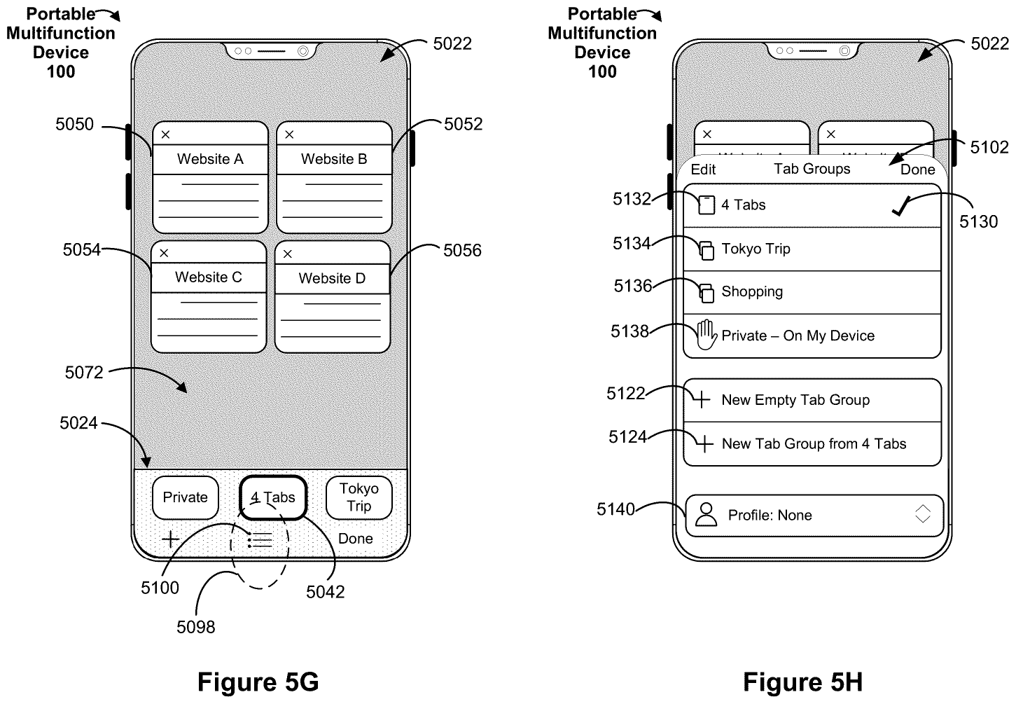

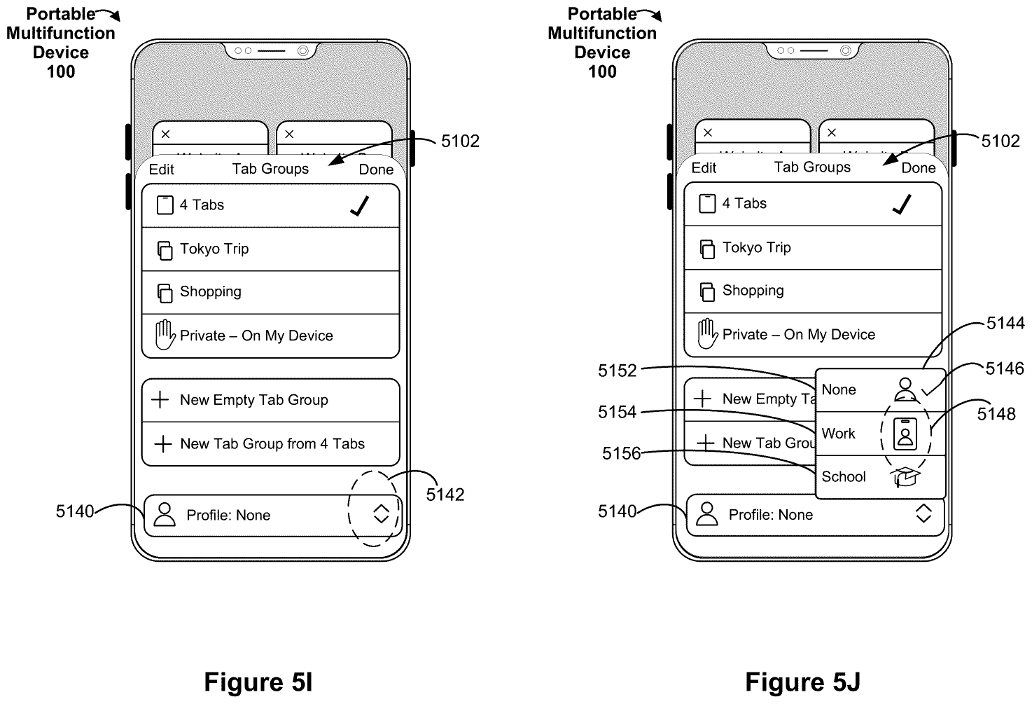

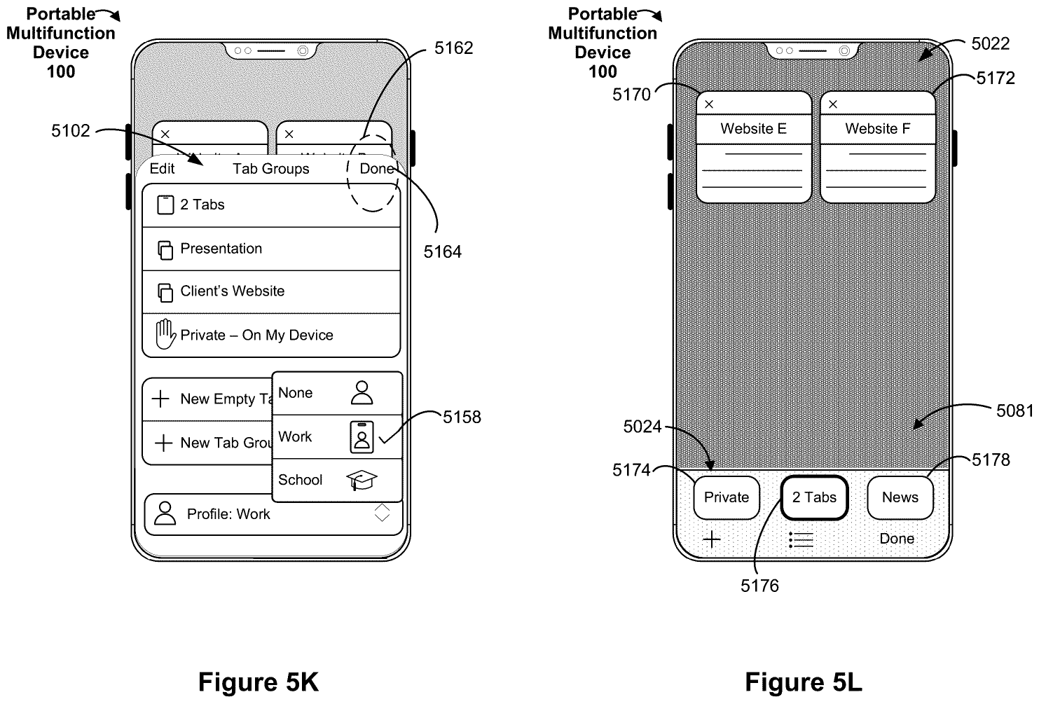

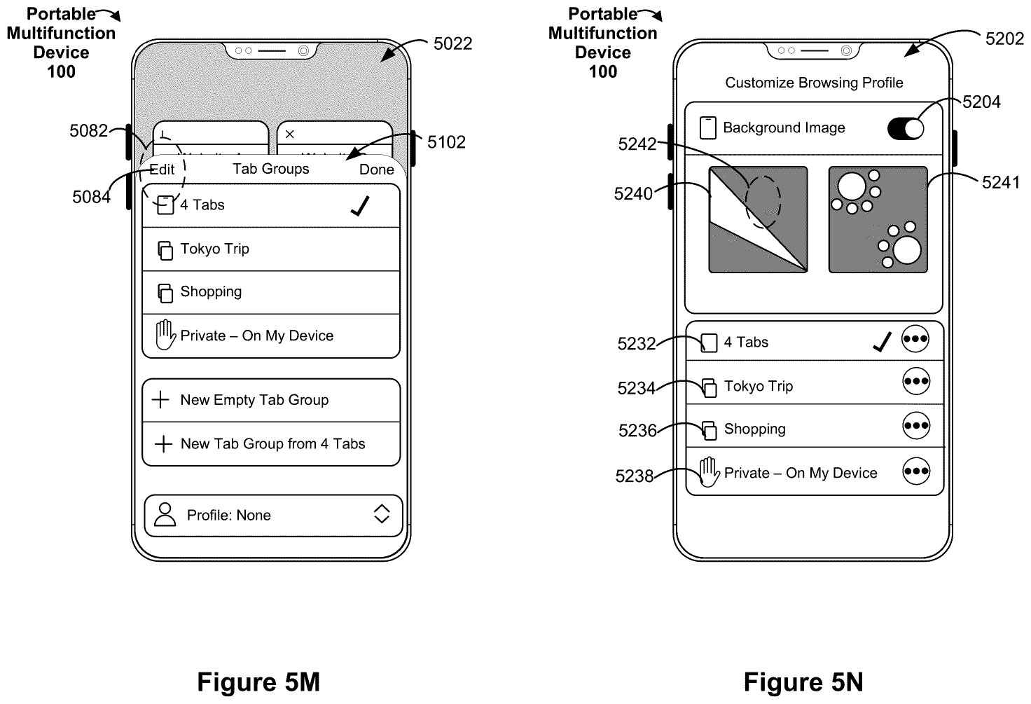

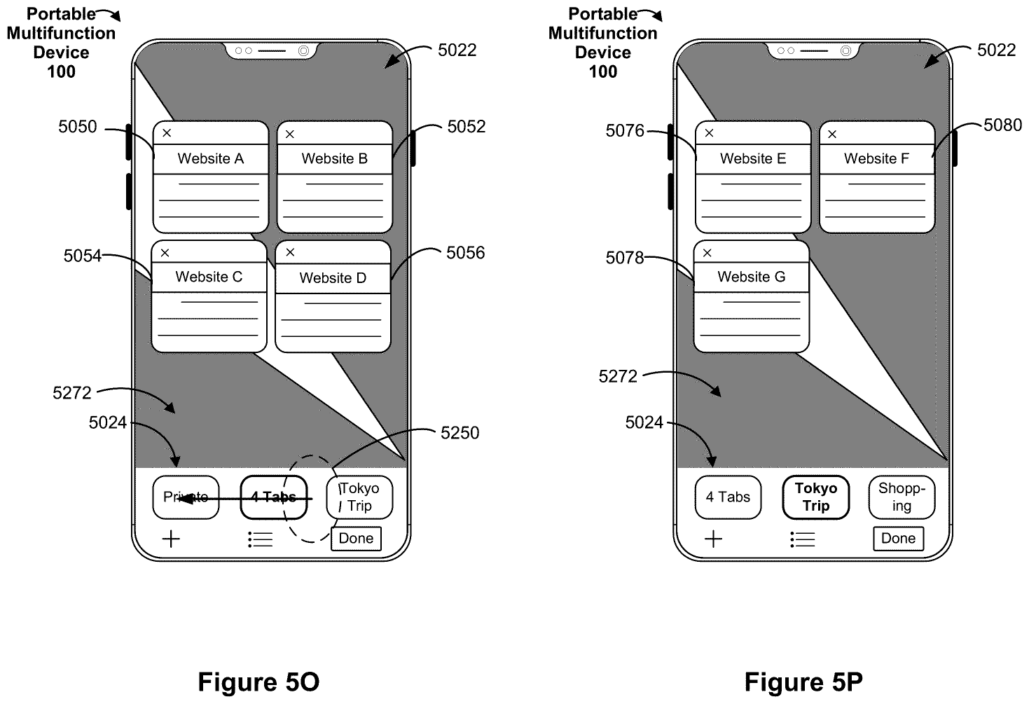

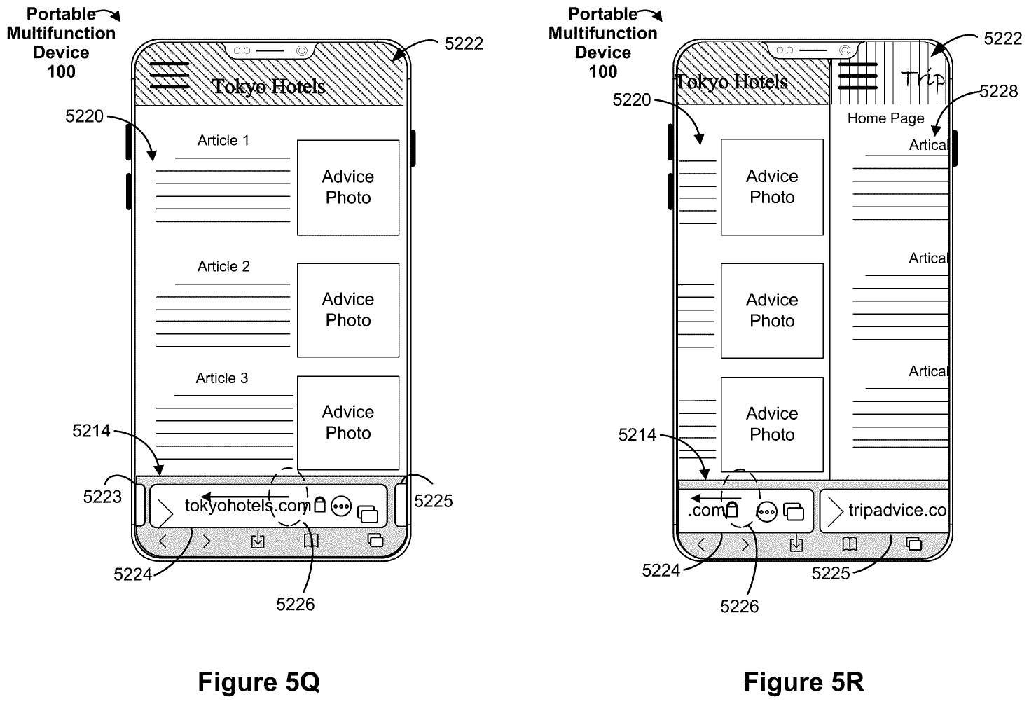

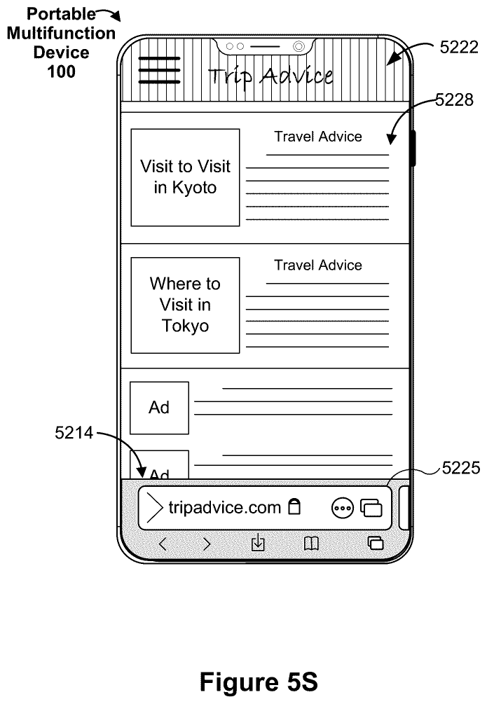

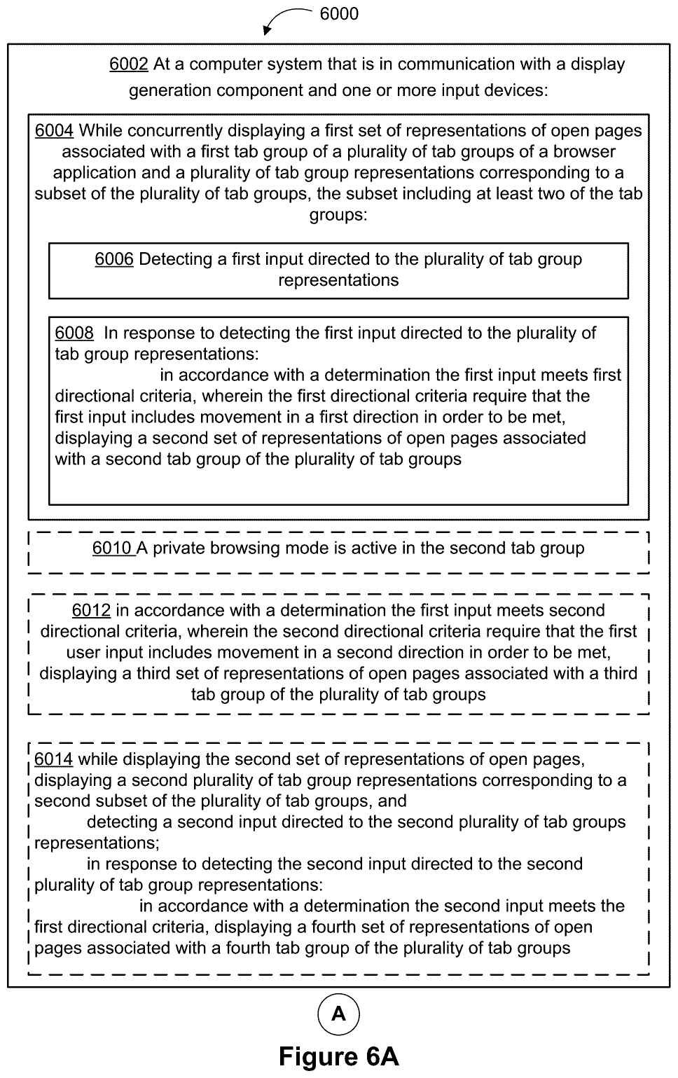

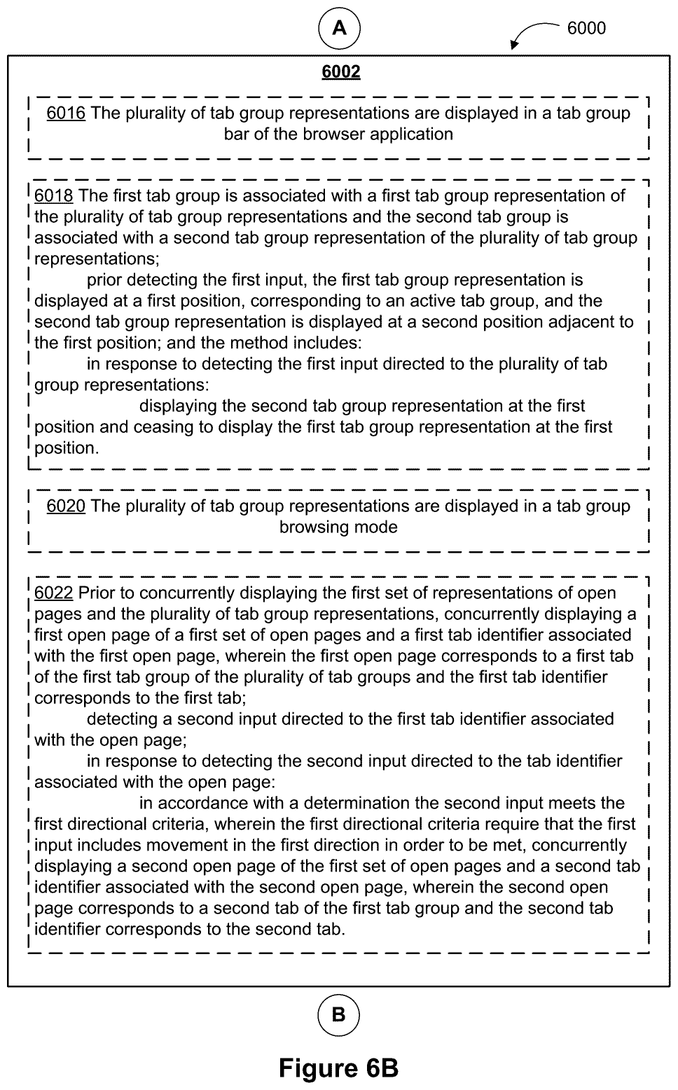

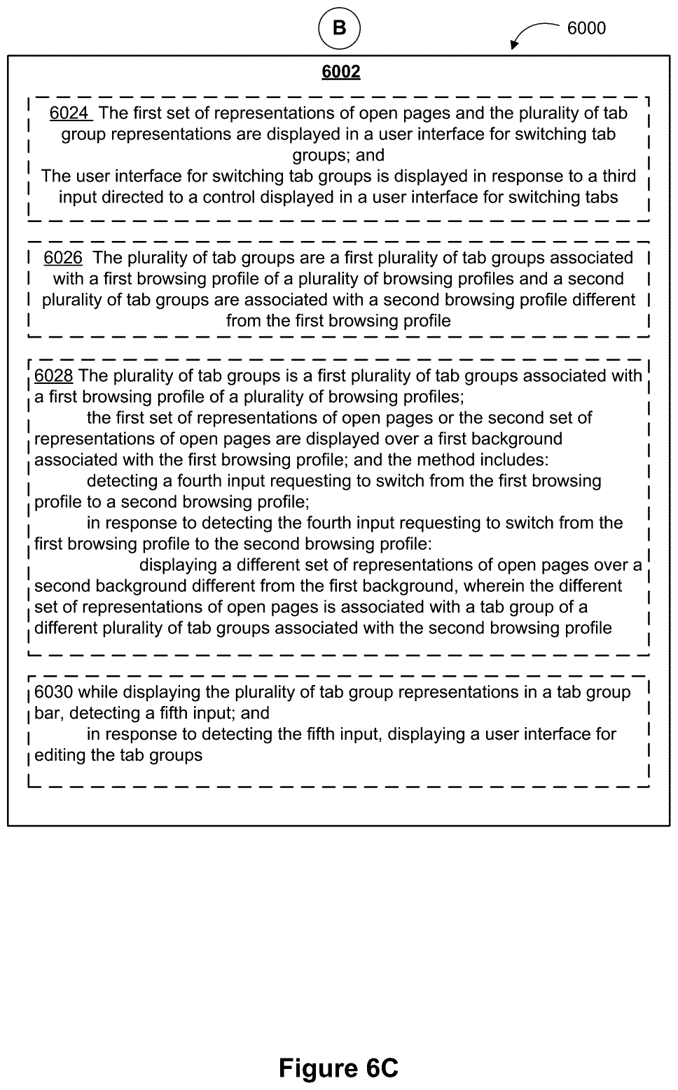

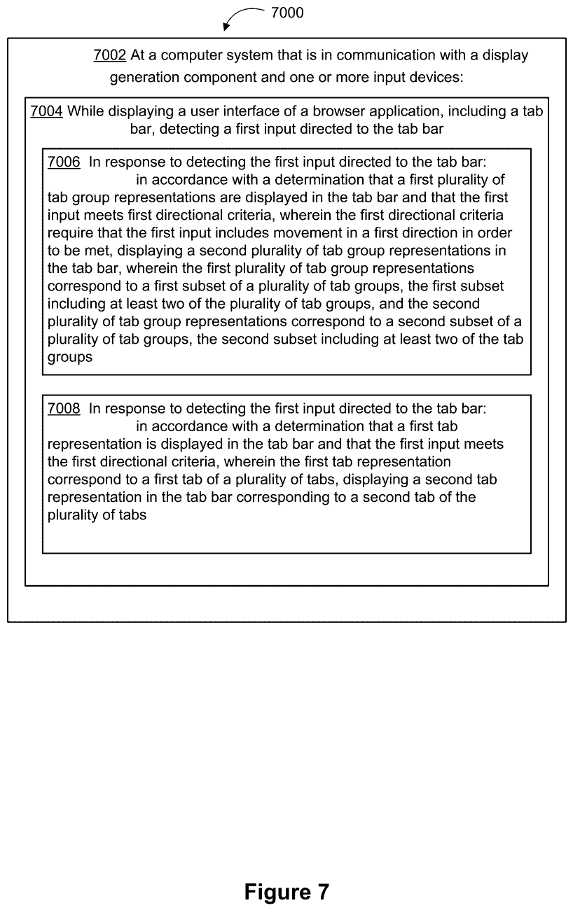

Below, FIGS. 1A-1B, 2, and 3 provide a description of example devices. FIGS. 4A-4B and 5A-5S illustrate example user interfaces for switching between tab groups in a browser application. FIGS. 6A-6C illustrate a flow diagram of a method of switching between tab groups in a browser application. FIG. 7 illustrate a flow diagram of a method of switching between tabs and tab groups in a browser application. The user interfaces in FIGS. 5A-5S are used to illustrate the processes in FIGS. 6A-6C and 7.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browser application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

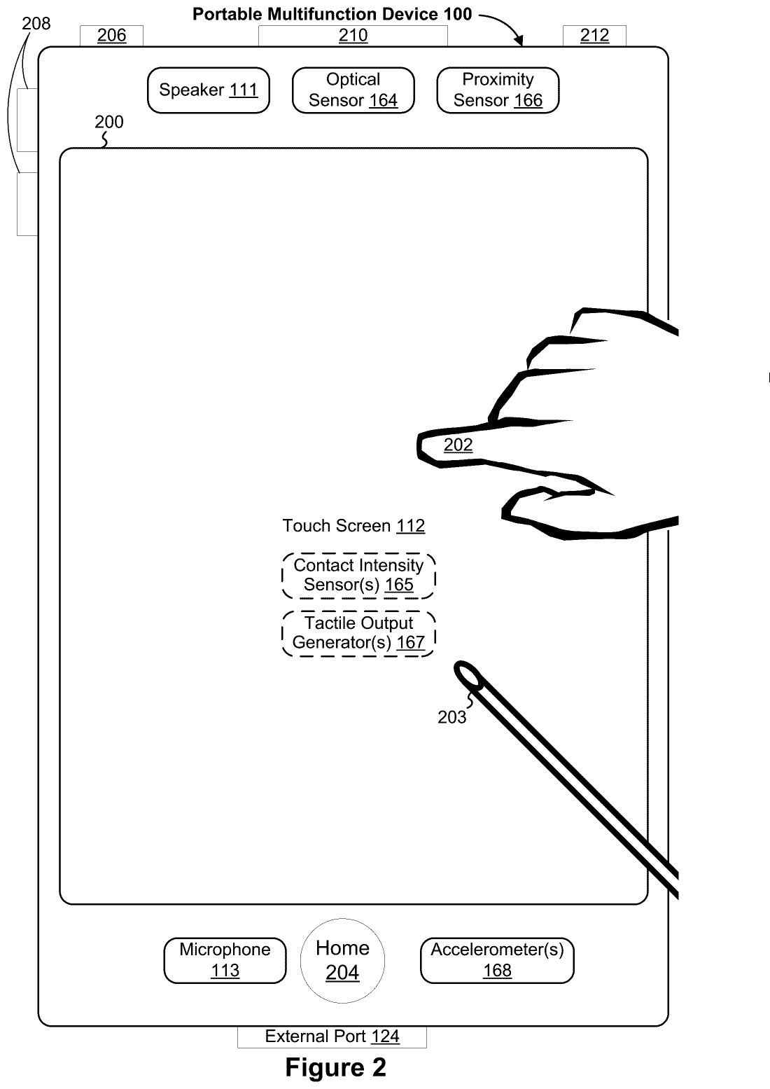

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, webpages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

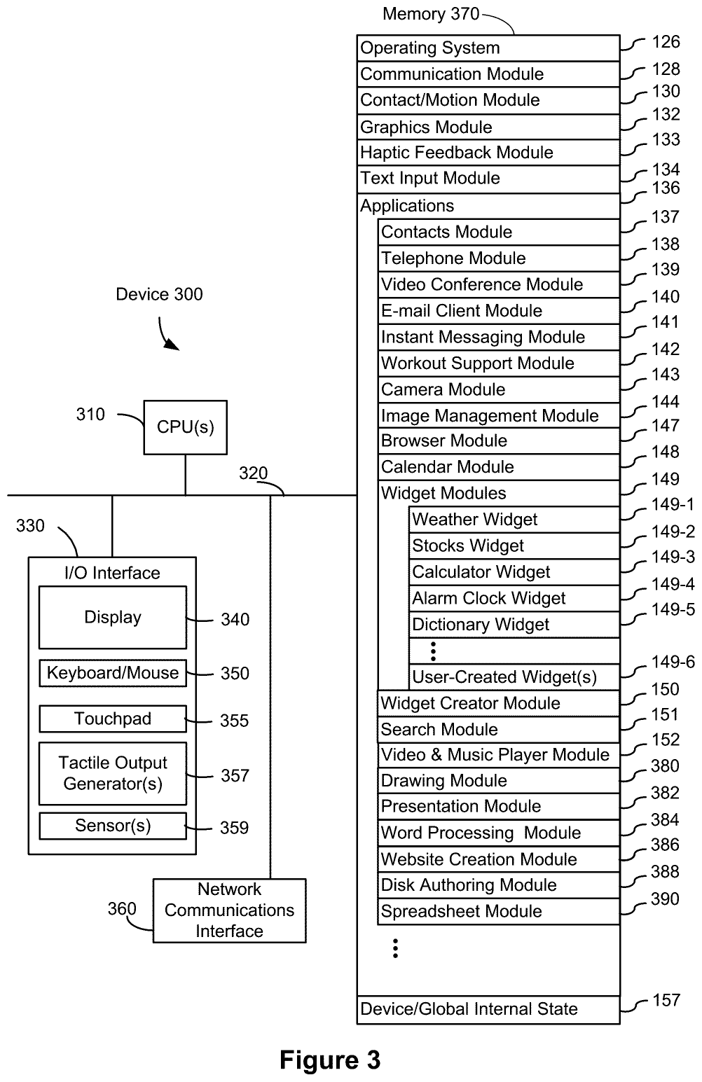

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, webpages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying webpages or portions thereof, as well as attachments and other files linked to webpages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a webpage into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5S illustrate example user interfaces for switching between tab groups in a browser application, in accordance with some embodiments. The user interfaces in these figures are used to illustrate the processes described below, including the processes in FIGS. 6A-6C and 7. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 5A-5S illustrate example user interfaces for switching tab groups using a swipe gesture, in accordance with some embodiments.

FIG. 5A illustrates portable multifunction device 100 with integrated touch-sensitive display 112. User interface 5002 of a web browser application (e.g., browser module 147, FIG. 1A or FIG. 3) is currently displayed on the touch-sensitive display 112. User interface 5002 shows content of a website “A” 5004. Further, user interface 5002 includes tab bar 5014. In some embodiments, tab bar 5014 includes name, address, or other identifier of a currently active tab. For example, tab 5006 in tab bar 5014 displays the name or URL address (sometimes called the URL, or uniform resource locator, or address) of website “A” 5004. Website “A” 5004 corresponds to the currently active tab and tab 5006 identifies the currently active tab. In some embodiments, a user can access a website (e.g., open a webpage at the website) by tapping or otherwise selecting tab 5006 while tab 5006 is blank, and entering the website's name or URL address. In some embodiments, tab 5006 is a smart search field and a user can enter a word or phrase to cause the portable multifunctional device 100 to display suggestions for websites based on the entered search word or phrase. Further, field 5012, which corresponds to an adjacent tab, is partially visible in tab bar 5014.

In some embodiments, user interface 5002 is displayed when the web browser application is in a tab browsing mode (e.g., as opposed to a tab group browsing mode). In the tab browsing mode, a user can navigate through open tabs. Further, optionally, in the tab browsing mode, open webpages are viewed in the user interface 5002 one at a time. User interface 5002 is sometimes referred to as a tab switcher user interface, since, as described herein, swipe gestures directed to tab bar 5014 (or tab bar 5214 in tab switcher user interface 5222 in FIGS. 5Q-5S), or directed to a tab identifier within tab bar 5014, cause the user interface 5002 to change (e.g., switch) which tab (e.g., which tab of a plurality of tabs in a currently selected tab group) is the active tab, and thus which webpage or website corresponding to the active tab is displayed in user interface 5002 (or user interface 5222). In some embodiments, webpages in user interface 5002 (or user interface 5022) are displayed at full scale (e.g., as opposed to reduced scale).

FIG. 5A illustrates a tap input 5008 directed to tab group button 5010 displayed in tab bar 5014.

FIG. 5B illustrates a transition from FIG. 5A in response to detecting the tap input 5008 on the tab group button 5010. In response to detecting tap input 5008, the portable multifunctional device 100 (referred also as device 100) displays tab group switcher user interface 5022. Tab group switcher user interface 5022 includes tab group bar 5024. In some embodiments, tab group bar 5024 is located at the bottom of tab group switcher user interface 5022. In some embodiments, tab group bar 5024 can be displayed at the top or as a side bar on the left or right side of tab group switcher user interface 5022. In some embodiments, tab group bar 5024 is used to navigate between different tab groups. Tab group bar 5024 includes tab group icon 5040, tab group icon 5042, and tab group icon 5044. Tab group icon 5040 represents a tab group, titled “Private” in this example, for private browsing (e.g., browsing in a private browsing mode). In some embodiments, search history and/or browsing history are not tracked when browsing in a private browsing mode. For example, device 100 or the browser application forgoes tracking when and/or what pages are opened and/or closed in the “Private” tab group. In some embodiments, other privacy configurations are applied in the private browsing mode.

Tab group icon 5042 represents a default tab group that includes a group of four currently open tabs. Since a name or title has not been assigned to the default tab group, tab group icon 5042 is titled “4 Tabs” in this example, indicating the number of tabs that are included in the default tab group. In some embodiments, the identifier or title of the default tab group is automatically determined and assigned by device 100. Tab group icon 5044 represents another tab group, titled “Tokyo Trip.” The group icon in the middle or center position in tab group bar 5024 illustrates a currently active tab group. In the example of FIG. 5B, the currently active tab group is the default tab group, as indicated by tab group icon 5042 being displayed in the middle position or slot in the tab group bar 5024. The currently active tab group represented by tab group icon 5042 is visually highlighted relative to tab group icons 5040 and 5044 that represent tab groups, in the tab group bar 5024, that are not currently active. In some embodiments, a tap input directed to a respective tab icon in the tab group bar 5024 causes device 100 to display open tabs included in the tab group selected by (e.g., in response to) the tap input directed to the respective tap icon. For example, device 100 displays tabs of “Private” tab group in response to selecting tab group icon 5040 (e.g., via a tap input directed to tab group icon 5040) or device 100 displays tabs of “Tokyo Trip” in response to selecting tab icon 5044 (e.g., via tap input directed to tab group icon 5044).

Further, tab group switcher user interface 5022 shows open tabs 5050-5056 that are included in the currently active tab group “4 Tabs.” Tab 5050 corresponds to open website “A” 5004, content (e.g., a webpage, or webpage content) of which was displayed in user interface 5002 prior detecting tap input 5008. Tab 5052 corresponds to open website “B”. Tab 5054 corresponds to open website “C”. Tab 5056 corresponds to open website “D”. In some embodiments, tabs 5050-5056 are reduced scale representations of respective websites “A”-“D”. For example, tab 5050 shows content of website “A” at reduced scale (e.g., such as a thumbnail showing a snapshot of the content of website “A” or content of website “A” that is being updated from a server, e.g., in real-time).

Optionally, tab group switcher user interface 5022 includes search field 5046 for searching open tabs (in the currently active tab group and/or other tab groups of the browser application). In some embodiments, tab group switcher user interface 5022 is displayed when the tab group browsing mode is active in the browser application. The tab group browsing mode is optionally activated in response to selecting tab group button 5010. In the tab group browsing mode, tab groups are viewed and navigated through (e.g., as opposed to individual tabs). In some embodiments, device 100 exits the tab group switch user interface 5022 in response to selecting a respective affordance, for example “Done” button 5048 (e.g., via a tap input) displayed in the tab group bar 5024. In some embodiments, when the device 100 exits the tab group switcher user interface 5022, the device 100 redisplays user interface 5002 that includes tab bar 5014 and displays a single open webpage at full scale. In some embodiments, in response to a user of device 100 selecting a tab from open tabs 5050-5056 (e.g., via a tap input), the device 100 ceases to display the tab group switcher user interface 5022 and displays the user interface 5002 showing webpage content of the selected tab. In some embodiments, a new tab is added to the currently active group in response to selecting “+” button 5058 (e.g., via a tap input) displayed in tab group bar 5024.

FIG. 5C illustrates a swipe input 5068 (e.g., by a user of device 100) in a leftward direction that is directed to tab group bar 5024. FIG. 5D illustrates a transition from FIG. 5C in response to the swipe input 5068. In response to the swipe input 5068, device 100 switches from “4 Tabs” tab group to “Tokyo Trip” tab group. For example, “Tokyo Trip” tab group, which is adjacent to “4 Tabs” tab group, is made the currently active tab group in response to swipe input 5068. FIG. 5D illustrates an intermediate state of tab group switcher user interface 5022 while transitioning from showing “4 Tabs” tab group to showing “Tokyo Trip” tab group in response to (and optionally while continuously detecting) swipe input 5068. As illustrated, “4 Tabs” tab group is assigned background theme 5072 (e.g., a grey background color without any patterns) and open tabs 5050-5056 included in “4 Tabs” tab group are displayed overlaying background theme 5072. In contrast, “Tokyo Trip” tab group is assigned background theme 5074 (e.g., a background filled with lines arranged in a pattern) and open tabs 5076-5078 included in “Tokyo Trip” tab group are displayed overlaying background 5074.

As illustrated, background themes 5072 and 5074 are different. In some embodiments, using distinct backgrounds for different tab groups provides additional visual feedback indicating what tab group is currently. In some embodiments, tab groups are not assigned distinct background themes. In some embodiments, some tab groups are assigned a distinct background theme and other tab groups can share the same background theme.

In some embodiments, a contact of swipe input 5068 optionally overlaps (at least partially) with or is directed to one or more of tab group icons 5040-5044 displayed in tab group bar 5024. For example, contact of swipe input 5068 partially overlaps with tab group icon 5044 of “Tokyo Trip” tab group. However, in some embodiments, for the swipe input 5068 to cause the device 100 to switch tab groups it is not required that swipe input 5068 is directed to any tab group icon of the tab group icons 5040-5044. In some embodiments, device 100 switches from “4 Tabs' tab group to “Private” tab group in response to a swipe input directed to the tab group bar 5024 in a rightward direction. In other words, a user can navigate back and forth between tab groups in response to swiping in leftward and rightward direction in the tab group bar 5024. In some embodiments, if the tab group bar 5024 is displayed as a side bar on the left or right side in the tab group switcher user interface 5022 (e.g., tab group bar 5024 is displayed in a vertical orientation as opposed to horizontal orientation as illustrated in FIG. 5B), a swipe input in the upward or downward direction is used to switch between tab groups.

FIG. 5E illustrates a transition from FIG. 5D in response to completion of the swipe input 5068. FIG. 5E shows a final state of the tab group switcher user interface 5022 in response to swipe input 5068. For example, in response to completion of swipe input 5068, open tabs 5076-5080 of “Tokyo Trip” tab group are displayed in the tab group switcher user interface 5022 and “Tokyo Trip” tab group becomes the currently active tab group (illustrated by highlighting tab group icon 5044 relative to adjacent tab group icons 5042 and 5045). In other words, device 100 switches from “4 Tabs” tab group to “Tokyo Trip” tab group in response to swipe input 5068. “Tokyo Trip” tab group includes a group of webpages that optionally are different from webpages included in the “4 Tabs” tab group. For example, open tab 5076 corresponds to website “E,” open tab 5078 corresponds to website “G,” and open tab 5080 corresponds to website “F.” In some embodiments, open tabs 5076-5080 in tab group switcher user interface 5022 are reduced scale representations of websites “E,” “F” and “G.” As illustrated, open tabs 5076-5080 of “Tokyo Trip” tab group are displayed overlaying background theme 5074. Further, in conjunction with displaying open tabs 5076-5080 in the tab group switcher user interface 5022, tab group icons 5040-5045 shift one position to the left in response to swipe input 5068. For example, tab group icon 5042 “4 Tabs” replaces tab group icon 5040 “Private” in the leftmost position in the tab group bar 5024, tab group icon 5044 “Tokyo Trip” replaces tab group icon 5042 “4 Tabs” in the middle or central position in the tab group bar 5024, and tab group icon 5045 “Shopping,” which was previously undisplayed, replaces tab group icon 5044 “Tokyo Trip” in the rightmost position in the tab group bar 5024. Further, FIG. 5E illustrates another swipe input 5088 in the leftward direction, where swipe input 5088 optionally follows swipe input 5068.

FIG. 5F illustrates a transition from FIG. 5E in response to swipe input 5088. In response to swipe input 5088, device 100 switches from tab group “Tokyo Trip” to tab group “Shopping.” For example, in response to swipe input 5088, open tabs 5090 and 5092 of “Shopping” tab group are displayed in the tab group switcher user interface 5022 and “Shopping” tab group becomes the currently active tab group (as indicated by tab group icon 5045 being highlighted relative to adjacent tab group icon 5044 and tab group icon 5040). “Shopping” tab group includes a group of webpages that optionally are different from webpages included in the “4 Tabs” tab group or the “Tokyo Trip” tab group. For example, open tab 5092 corresponds to (e.g., shows a webpage of) website “H” and open tab 5094 corresponds to website “I.” In some embodiments, open tabs 5092-5094 are reduced scale representations of websites “H”-“I.” As illustrated, open tabs 5092-5094 of “Shopping” tab group are displayed overlaying background theme 5096, which is different from background theme 5074 of “Tokyo Trip” tab group and background theme 5072 of “4 Tabs” tab group.

Further, in conjunction with displaying open tabs 5092-5094 in the tab group switcher user interface 5022, tab group icons 5040-5045 shift one position to the left in response to swipe input 5088. In some embodiments, repeat swipe inputs in the same direction can cause device 100 to cycle through tab groups, such that device 100 switches from the last tab group in a set of tab groups being the currently active tab group to the first tab group in the set of tab groups being the currently active tab group. In the example in FIGS. 5A-5F, four tab groups are available (e.g., currently exist, or currently defined) in the browser application, e.g., “Private,” “4 Tabs” (which is the default tab group), “Tokyo Trip,” and “Shopping.” Once the device cycles through all four tab groups, the “Private” tab group optionally reappears, as illustrated by the dashed outline of tab group icon 5040 in tab group bar 5024 in FIG. 5F. For example, in response to swipe input 5088, tab group icon 5045 representing tab group “Shopping” replaces tab group icon 5044 representing “Tokyo Trip” in the middle position in the tab group 5024, and tab group icon 5040 representing “Private” tab group reappears in the rightmost position in the tab group bar 5024 in place of tab group icon 5045 representing tab group “Shopping.” Further, tab group icon 5044 representing “Tokyo Trip” replaces tab group icon 5042 representing “4 Tabs” in the leftmost position in the tab group bar 5024.

FIG. 5G shows tab group switcher user interface 5022 when “4 Tabs” tab group is currently active in the browser application. For example, open tabs 5050-5056 that are included in the “4 Tabs” tab group are displayed in the tab group switcher user interface 5022 and tab group icon 5042 representing the “4 Tabs” tab group is displayed in the middle position in the tab group bar 5024. In some embodiments, background theme 5072 is associated with a currently active browsing profile, where open tabs are displayed over background theme 5072 in the tab group switcher user interface 5022. Further, FIG. 5G shows a tap input 5098 directed to edit button 5100 (e.g., for initiating editing tab groups).

FIG. 5H illustrates a transition from FIG. 5G in response to tap input 5098 directed to edit button 5100. In response to tap input 5098 directed to edit button 5100, device displays a user interface 5102 for editing tab groups. For example, a user can create a new empty tab group by tapping on (or otherwise selecting) add tab group button 5122. Further, a user can create a new tab group from currently open tabs 5050-5056 in the default tab group “4 Tabs” by tapping (or otherwise selecting) tab group button 5124. In the example in FIG. 5H, the currently selected tab group is the default “4 Tabs” group, and a user of device 100 can switch to a different tab group by selecting one of other tab group icons 5134-5138 (e.g., via a tap input directed to a respective tab group icon). Check mark 5130, adjacent tab group icon 5132, indicates that “4 Tabs” tab group is the tab group that is currently active. In some embodiments, user interface 5102 for editing tab groups is displayed overlaying tab group switcher user interface 5022. In some embodiments, a user can exit the user interface 5102 for editing tab groups by tapping on an area in the screen that corresponds to the tab group switcher user interface 5022 and that is not overlayed by the user interface 5102 for editing tab groups.

In some embodiments, tab groups can be included in or associated with different browsing profiles. In that way, web browsing activity can be separated into different browsing profiles. For example, a user can create browsing profiles for work, school, different projects, and/or other criteria or characteristics. In some embodiments, in FIG. 5H, browsing profile icon 5140 shows that there is no user-defined browsing profile that is currently active. For example, the tab groups “Private,” “4 Tabs” (which is the default tab group), “Tokyo Trip,” and “Shopping” are not associated with or assigned to a user-defined browsing profile, and instead are associated with a default browsing profile.

FIG. 5I illustrates a tap input 5142 directed to browsing profile icon 5140. FIG. 5J illustrates a transition from FIG. 5I in response to tap input 5142. In response to detecting tap input 5142, device 100 displays menu 5144 with options 5152-5156 in FIG. 5J. Option 5154 corresponds to work browsing profile and option 5156 corresponds to a school browsing profile. Option 5152 corresponds to a default browsing that is not assigned to a particular browsing profile. Checkmark 5146 indicates that no user-defined browsing profile is currently active in the browser application. Further, FIG. 5J illustrates a tap input 5148 selecting option 5154 that corresponds to the work browsing profile. FIG. 5K shows a transition from FIG. 5J in response to detecting tap input 5148 selecting option 5154. In response to detecting tap input 5148 optionally checkmark 5158 is displayed near or at option 5154 indicating that the work browsing profile is selected or active. FIG. 5K further illustrates a tap input 5162 directed to “Done” button 5164.

FIG. 5L illustrates a transition from FIG. 5K in response to detecting the tap input 5162 directed to “Done” button 5164. In response to detecting tap input 5162 directed to “Done” button 5164, device 100 exits user interface 5102 for editing tab groups. Further, in response to selecting the work profile via tap input 5148 prior exiting the user interface 5102 and optionally in conjunction with tap input 5162, device 100 switches to work browsing profile. When device 100 switches from the default browsing profile to the work browsing profile, tab groups that are associated with the work browsing profile are made available for viewing and navigating in the tab group switcher user interface 5022 (and optionally other tab groups that are not included in the work browsing profile are inaccessible unless the device 100 exits from the work browsing profile). For example, tab group switcher user interface 5022 displays open tabs 5170-5172 included in a default browsing tab group “2 Tabs” that is included in the work browsing profile. Further, while the work browsing profile is active, tab group representations or icons in the tab group bar 5024 represent respective tab groups in the work browsing profile. For example, tab group icon 5176 representing the default tab group “2 Tabs” is displayed in tab group bar 5024. Further, tab group icon 5174 representing tab group “Private” for private browsing that is associated with the work browsing profile is also displayed in tab group bar 5024. Further, tab group icon 5178 representing “News' tab group associated with the work browsing profile is also displayed in the tab group bar 5024. As illustrated, in FIG. 5L, open tabs 5170-5172 are displayed overlaying a background theme 5081 that is different from other background themes, such as background theme 5072 assigned to “4 Tabs” tab group or background theme 5074 assigned to “Tokyo Trip” tab group.

Alternatively, in some embodiments, FIG. 5L (described above) illustrates a transition in response to tap input 5148, as shown in FIG. 5L (e.g., without requiring the user to also select a “Done” button 5164 to transition to the tab group switcher user interface 5022 while in the user-selected work browsing profile).

FIG. 5M illustrates user interface 5102 for editing tab groups that is displayed in response to tap input 5098 directed to edit button 5100 in FIG. 5G. In FIG. 5M, device 100 detects a tap input 5082 directed to edit button 5084 in user interface 5102 for editing tab groups. FIG. 5N illustrates a transition from FIG. 5M in response to detecting tap input 5082 directed to edit button 5084. In response to detecting tap input 5082 directed to edit button 5084, device 100 displays user interface 5202 for customizing a currently active browsing profile and any associated tab groups. User interface 5202 includes toggle option 5204 for enabling assignment of a background theme to the currently active browsing profile. In the case of FIGS. 5M-5N, the currently active browsing profile is the default browsing profile (e.g., computer generated) that includes four tabs groups represented with tab group icons 5232-5238. Toggle option 5204 illustrates that assigning a background theme to the currently browsing profile is enabled in FIG. 5N. User interface further 5202 includes background themes 5240 and 5241 available for user selection. In some embodiments, more than two background themes are presented in user interface 5102 for editing tab groups. In FIG. 5N, device 100 detects a tap input 5244 directed to background theme 5240.

FIG. 5O illustrates a transition from FIG. 5N in response to tap input 5242 directed to background theme 5240. In response to tap input 5242 directed to background theme 5240, device 100 displays open tabs 5050-5056 of “4 Tabs” tab group overlaying background theme 5272 in the tab group switcher user interface. Background theme 5272 is different from background theme 5072 as illustrated in FIGS. 5D and 5G. In some embodiments, a background theme can be assigned to or at the level of a browsing profile (e.g., as opposed to at the tab group level), in which case tabs of tab groups included in the respective browsing profile are displayed overlaying the same background theme that is assigned to the respective browsing profile. This is illustrated in FIGS. 50 and 5P. In FIG. 50, device 100 detects a swipe input 5250 in a leftward direction and directed to a location in the tab group bar 5024.

FIG. 5P illustrates a transition from FIG. 5O in response to the swipe input 5250. In response to swipe input 5250 in the leftward direction directed to a location in the tab group bar 5024, device 100 switches from “4 Tabs” tab group to “Tokyo Trip” tab group. Since background theme 5272 is assigned to the browsing profile that is active, as described above, open tabs 5076-5080 of “Tokyo Trip” tab group are displayed overlaying the same background theme 5272 as open tabs 5050-5056 of “4 Tabs” tab group in the tab group switcher user interface 5022.

FIG. 5Q-5S illustrates example user interfaces for switching tabs using a swipe gesture, in accordance with some embodiments.

FIG. 5Q illustrates a tab switcher user interface 5222, in which webpage content 5220 of a “Tokyo Hotels” webpage is viewed in a tab browsing mode. For example, in the tab browsing mode of the browser application, individual open tabs are viewed at full scale (e.g., as opposed to a tab group browsing mode in which multiple open tabs of a single tab group are viewed at reduced scale). Tab 2224 corresponding to or representing “Tokyo Hotels” webpage is displayed in tab bar 5214 in tab switcher user interface 5222. Further, tabs 5223 and 5225 that are adjacent to tab 5224 (which is currently active) are partially displayed in tab bar 5214 indicating that additional tabs are open. In FIG. 5Q, device 100 detects a swipe input 5226 directed to tab 5224. In some embodiments, swipe input 5226 is directed to a location in tab bar 5214 but it is not necessary that swipe input 5226 is directed to a specific tab, such as tab 5224, for device 100 to switch to a different tab. In some embodiments, it is required that swipe input 5226 is directed to tab 5224 or other tab for device 100 to switch to a different tab.

FIG. 5R illustrates a transition from FIG. 5Q in response to detecting swipe input 5226 directed tab 5224. In response to detecting swipe input 5226 directed to tab 5224, device 100 switches from displaying webpage content 5220 of tab 5224 in the tab switcher user interface 5222 to displaying webpage content 5228 of tab 5225. FIG. 5R shows an intermediate state illustrating a transition from displaying webpage content of tab 5224 to displaying webpage content of tab 5225 in response to detecting swipe input 5226.

FIG. 5S illustrates a transition from FIG. 5R in response to completing swipe input 5226. In response to completing swipe input 5226, device 100 displays webpage content 5228 of tab 5225 at full scale in tab switcher user interface 5222. Tab 2225 corresponding to or representing “Trip Advice” webpage is displayed in tab bar 5214 in tab switcher user interface 5222.

FIGS. 6A-6C are flow diagrams illustrating method 6000 of switching tab groups in a browser application (sometimes called a browsing application, a web browser, or internet browser), in accordance with some embodiments. Method 6000 is performed at an electronic device (e.g., device 300, FIG. 3, or portable multifunction device 100, FIG. 1A) that is in communication with a display and a touch-sensitive surface. In some embodiments, the display is a touch-screen display and the touch-sensitive surface is on or integrated with the display. In some embodiments, the display is separate from the touch-sensitive surface. Some operations in method 6000 are, optionally, combined and/or the order of some operations is, optionally, changed.

As described herein, method 6000 allows a user to efficiently switch between tab groups in a browser application. Some conventional methods require a sequence of inputs navigating menus or other controls to switch from one tab group to another. Searching for the correct menu option or control can be tedious and time consuming. Additionally, the menus and/or controls clutter the browser application's user interface. The method 6000 allows a user to switch between tab groups using a swipe gesture directed to a tab bar in which tab group representations are displayed (optionally the swipe gesture is directed to one or more tab group representations). Switching from one tab group to another in response to a swipe gesture reduces the number of inputs and the amount of time necessary to navigate tab groups in the browser application, thereby providing making the user-device interaction more efficient without cluttering the user interface of the browser application with additional controls.

In some embodiments, method 6000 is performed (6002) at a computer system (e.g., device 300, FIG. 3, or portable multifunction device 100, FIG. 1A) that is in communication with a display generation component (e.g., touch screen 112 or display 450) and one or more input devices (e.g., touch screen 112 or touch-sensitive surface 451). While concurrently displaying (6004) a first set of representations of open pages (e.g., open tabs 5050-5056 in FIG. 5B) associated with a first tab group (e.g., a tab group, which is currently active, such as default tab group “4 Tabs” in FIG. 5B) of a plurality of tab groups (e.g., “Private,” “4 Tabs,” and “Tokyo Trip” tabs groups in FIG. 5b) of a browser application and a plurality of (selectable) tab group representations (e.g., two or more tab group representations, such as tab group icons 5040, 5042, and 5044 in FIG. 5B) corresponding to a subset of the plurality of tab groups, the subset including at least two (or three) of the tab groups (e.g., at least a private browsing tab group and a default tab group for currently open tabs), the computer system (e.g., device 100) detects (6006) a first input (e.g., a swipe gesture, such as swipe input 5068 or swipe input 5088) directed to the plurality of tab group representations (or optionally directed anywhere in a tab bar, where the tab group representations are displayed. In some embodiments, the tab group representations each include a respective tab group identifier or name. In some embodiments, the first set of representations of open pages correspond to one, two, less than all, or all representations of open pages associated with the first tab group. In some embodiments, the first set of representations of open pages are thumbnail representations or other reduced scale representations of open webpages. In some embodiments, the first set of representations of open pages and the plurality of tab group representations are displayed in a user interface for switching tab groups (e.g., a tab group switcher user interface 5022 in FIGS. 5B-5G, 5L, and 50-5P.

In response to detecting the first input directed to the plurality of tab group representations and in accordance with a determination the first input meets first directional criteria (e.g., criteria that require a horizontal or lateral swipe in a leftward or rightward direction), wherein the first directional criteria require that the first input includes movement in a first direction in order to be met, the computer system displays (6008) a second set of representations of open pages (e.g., open tabs 5076-5080 in FIG. 5E) associated with a second tab group of the plurality of tab groups (e.g., “Tokyo Trip” tab group represented by tab 5044 in FIG. 5E). In some embodiments, the second tab group becomes the currently active group. In some embodiments, the second set of representations of open pages are displayed without ceasing to display at least two or more of the plurality of tab group representations (e.g., tab group icons 5042, 5044, and 5045 are displayed in tab group bar 5024 in FIG. 5E). In some embodiments, the first tab group is associated with a first tab group representation of the plurality of tab group representations and the second tab group is associated with a second tab group representation of the plurality of tab group representations. In some embodiments, the first set of representations of open pages or the second set of representations of open pages are displayed in a first region of the browser application (e.g., the first region displays an overview of open pages or a single open page). In some embodiments, the subset of the plurality of tab group representations is displayed in a second region of the browser application. In some embodiments, the second region corresponds to a tab group bar (e.g., tab group bar 5024 in FIG. 5E). In some embodiments, the tab group bar is displayed at top or bottom edge of the display (e.g., tab group bar 5024 is displayed at the bottom in FIG. 5B-5G). In some embodiments, the tab group bar is a side bar displayed at a left or right edge of the display.

In some embodiments, in conjunction with displaying the second set of representations of open pages associated with the second tab group, the computer system displays a second plurality of tab group representations corresponding to a second subset of the plurality of tab groups (e.g., tab group icon 5045 corresponding “Shopping” tab group is displayed in tab group bar 5024 while tab group icon 5040 is no longer displayed in FIG. 5E).

In some embodiments, the first input directed to the plurality of tab group representations is a swipe input (e.g., swipe input 5068 or swipe input 5088). In some embodiments, the swipe input is a lateral or horizontal swipe input in a leftward or rightward direction. In some embodiments, the computer system switches (e.g., scrolls) between adjacent tab groups (and associated tab group representations) in response to the first input. In some embodiments, the first input directed to the plurality of tab group representations is a scrolling input, and in response, the computer system switches between both adjacent and non-adjacent tab groups (and associated tab group representations). For example, the second tab group (and associated second tab group representation) is displayed in accordance with magnitude and/or direction of the scrolling input, where one or more other tab groups (and associated tab group representations) separate the first tab group and the second tab group. In some embodiments, a distinct background (e.g., color, theme, or wallpaper) is assigned to a tab group of the plurality of tab groups. For example, each tab group of the plurality of tab groups is associated with a different background (e.g., “4 Tabs” tab group is associated with background 5072, as shown in FIG. 5D; and “Tokyo Trip” tab group is associated with background 5074, as shown in FIG. 5E; “Shopping” tab group is associated with 5096, as shown in FIG. 5F). For example, while the first tab group is active, the first set of representations of open pages are displayed over (or overlaid on) a first background, and, in response to switching to the second tab group, the second set of representations of open pages are displayed over (or overlaid on) a second background different from the first background.

In some embodiments, in accordance with a determination that the first input does not meet the first directional criteria (e.g., the first input corresponds to vertical swipe in an upward or downward direction), the computer system forgoes displaying the second set of representations of open pages (optionally the computer system performs a different operation, such as displaying a different user interface of the browser application or ceasing to display a user interface of the browser application).

In some embodiments, a private browsing mode is (6010) active in the second tab group (or at least one tab group of the plurality of tab groups).

In some embodiments, in accordance with a determination the first input meets second directional criteria (e.g., horizontal or lateral swipe in a leftward or rightward direction), wherein the second directional criteria require that the first user input includes movement in a second direction (e.g., different from the first direction or opposite of the first direction) in order to be met, the computer system displays (6012) a third set of representations of open pages associated with a third tab group of the plurality of tab groups (e.g., the third tab group different from the first tab group and the second tab group). For example, in response to a swipe input in a rightward direction in FIG. 5C, device 100 displays any open tabs of the “Private” tab group. Navigating back and forth between tab groups using swipe gestures reduces the number of input and extent of inputs necessary to switch from one tab group to another.

In some embodiments, while displaying the second set of representations of open pages (e.g., open tabs 5076-5080 in FIG. 5E), the computer system displays a second plurality of (selectable) tab group representations (e.g., tab group icons 5044, 5045, and 5042 in tab group bar 5024 in FIG. 5E) corresponding to a second subset of the plurality of tab groups, and the computer system detects (6014) a second input directed to the second plurality of tab groups representations. In response to detecting the second input directed to the second plurality of tab group representations and in accordance with a determination the second input (e.g., swipe input 5088) meets the first directional criteria (and optionally in accordance with a determination that the second input follows the first input), the computer system displays a fourth set of representations of open pages associated with a fourth tab group of the plurality of tab groups (e.g., the fourth tab group is different from the first tab group, second tab group and third tab group). For example, in response to swipe input 5088 in FIG. 5E, device 100 displays open tabs 5092-5094 of “Shopping” tab group in tab group switcher user interface 5024 in FIG. 5F. Using a swipe gesture directed to a tab group bar (or other tab bar and/or tab group representations) to navigate to an adjacent tab group reduces the number and extent of inputs necessary to switch to an adjacent tab.

In some embodiments, in conjunction with displaying a fourth set of representations of open pages associated with the fourth tab group, a fourth tab group representation associated with the fourth tab group is displayed (optionally replacing another tab group representation that was visible (e.g. in a tab group bar) prior detecting the second user input directed to the second plurality of tab group representations). For example, tab group icons 5044, 5045, and 5040 are displayed in tab group bar 5024 in FIG. 5F). In some embodiments, the plurality of tab group representations (and associated plurality of tab groups) are ordered in a sequence. In some embodiments, the second tab group representation (and the second tab group) are adjacent to the fourth tab group representation (and fourth tab group) in the sequence. In other words, the computer system switches between adjacent tab groups and tab group representations in response to the second user input. Using a swipe gesture directed to a tab group bar (or other tab bar and/or tab group representations) to navigate to an adjacent tab group reduces the number and extent of inputs necessary to switch to an adjacent tab.

In some embodiments, the second tab group representation (and the second tab group) is separated from the fourth tab group representation (and fourth tab group) by one or more other group representations, such that the second tab group is not adjacent to the fourth tab group. For example, in some embodiments, in response to the second user input directed to the second plurality of tab group representations, the computer system scrolls through one or more other tab group representations (and/or tab groups) until selecting the fourth tab group (and associated tab group representation). Using a swipe gesture directed to a tab group bar (or other tab bar and/or tab group representations) to navigate and scroll through multiple tab groups reduces the number and extent of inputs necessary to switch to an adjacent tab.

In some embodiments, the plurality of tab group representations are displayed (6016) in a tab group bar of the browser application (e.g., tab group bar 5024 in FIGS. 5B-5G). In some embodiments, when switching between tab groups in response to swipe gestures in the tab group bar, the computer system maintains display of the tab group bar while the representations of tab groups shift in the tab group bar.

In some embodiments, the first tab group is associated (6018) with a first tab group representation of the plurality of tab group representations (e.g., “4 Tabs” tab group is associated with tab group icon 5042 in FIGS. 5B-5G) and the second tab group is associated with a second tab group representation of the plurality of tab group representations (“Tokyo Trip” tab group is associated with tab group icon 5044 in FIGS. 5B-5G). Prior to detecting the first input, the first tab group representation is displayed at a first position, corresponding to an active tab group, and the second tab group representation is displayed at a second position adjacent to the first position. In response to detecting the first input directed to the plurality of tab group representations, the computer system displays the second tab group representation at the first position and ceases to display the first tab group representation at the first position (e.g., tab group icon 5044 corresponding to “Tokyo Trip” tab group replaces tab icon 5042 corresponding to “4 Tabs” tab group in response to swipe gesture 5068 detected in FIG. 5C). In some embodiments, the first tab group representation is replaced with the second tab group representation at the first position. In some embodiments, the second position is not adjacent to the first position, such that one or more other positions occupied by one or more other tab group representations separate the first position and the second position.

In some embodiments, the plurality of tab group representations are displayed (6020) in a tab group browsing mode of the browser application. For example, tab group icons 5040-5044 in FIG. 5C are displayed in the tab group browsing mode of the browser application. Further, tab group icons 5042, 5044, and 5045 in FIG. 5E and tab group icons 5044, 5045, and 5040 in FIG. 5F are displayed in the tab group browsing mode. In some embodiments, the tab group browsing mode is a mode of the browser application in which tab groups are viewed, edited, and navigated (as opposed to a tab browsing mode in which open tabs (and associated webpages) are viewed and navigated). In some embodiments, a tab group switcher user interface (e.g., tab group switcher user interface 5022 in FIG. 5B-5G or 50-5P) is displayed in the tab group browsing mode.

In some embodiments, prior to concurrently displaying the first set of representations of open pages and the plurality of tab group representations, the computer system concurrently displays (6022) a first open page of a first set of open pages (without displaying other open pages of the first set of open pages) and a first tab identifier associated with the first open page (e.g., webpage address, name, or other identifier or representation), wherein the first open page corresponds to a first tab of the first tab group of the plurality of tab groups and the first tab identifier corresponds to the first tab (e.g., website “A” 5004 and associated tab 5006 in tab bar 5014 in FIG. 5A). For example, prior detecting tap input 5008 directed to tab group button 5010, user interface 5002 of the web browser application displays content of website “A” 5004 at full scale concurrently with tab 5006 that shows URL address of website “A.” In some embodiments, the first open page and the first tab identifier that corresponds to the first open page are displayed in a user interface for switching tabs (e.g., a tab switcher user interface 5222 in FIGS. 5Q-S). The computer system detects a second input (e.g., a swipe gesture) directed to the first tab identifier associated with the open page (e.g., swipe input 5226 directed to tab 5224 in FIG. 5Q, or alternatively directed to tab bar 5214 in FIG. 5Q). In response to detecting the second input directed to the tab identifier associated with the open page (or in response to detecting the second input directed to tab bar 5214) and in accordance with a determination the second input meets the first directional criteria (e.g., criteria requiring a horizontal or lateral swipe in a leftward or rightward direction), wherein the first directional criteria require that the first input includes movement in the first direction in order to be met, the computer system concurrently displays a second open page of the first set of open pages and a second tab identifier associated with the second open page, wherein the second open page corresponds to a second tab of the first tab group and the second tab identifier corresponds to the second tab. For example, in FIG. 5S, device 100 displays webpage content 5228 of tab 5225 at full scale and associated tab 5225 in tab switcher user interface 5222. Using a swipe gesture directed to a tab bar (or a tab group bar) to switch between tabs or to switch between tab groups reduces the number and extent of inputs necessary to navigate tabs and tab groups in a browser application.

In some embodiments, the open page of the first set of open pages and the tab identifier associated with the open page are displayed when the browser application is in a tab browsing mode (e.g., the browser application is in the tab browsing mode in FIGS. 5Q-5S). For example, navigation requests (e.g., swipe gestures directed to a tab bar) switch between open pages (and associated tabs), as opposed to switching between tab groups. In some embodiments, in the tab browsing mode the open page of the first set of open pages is displayed without displaying other open pages (e.g., other open pages of the same or other tab group) and the tab identifier is displayed without displaying representations of tab groups. In some embodiments, a tab switcher user interface is displayed in the tab browsing mode (e.g., tab switcher user interface 5222 in FIGS. 5Q-5S).

In some embodiments, the computer system switches from the tab switcher user interface (or the tab browsing mode of a browser application) to the tab group switcher user interface (or tab group browsing mode of the browser application) in response to detecting a user input (e.g., tap input 5008 in FIG. 5A) selecting a control that is visible in the tab switcher user interface (e.g., tab group button 5010 in FIG. 5A). In some embodiments, the computer system switches from the tab group switcher user interface to the tab switcher user interface in response to selecting a representation of an open page from a displayed set of representations of open pages (displayed in the tab group switcher user interface), for example the first set of representations of open pages or the second set of representations of open pages. For example, the device 100 switches from tab group switcher user interface 5022 in FIG. 5C back to tab switcher user interface 5002 in FIG. 5A in response to detecting an input selecting (e.g., via a tap input) tab 5050 in FIG. 5B or 5C.

In some embodiments, the first set of representations of open pages and the plurality of tab group representations are displayed (6024) in a user interface for switching tab groups (e.g., a tab group switcher user interface of the browser application). The user interface for switching tab groups is displayed in response to a third input (e.g., a tap or long press input) directed to a control displayed in a user interface for switching tabs (e.g., a tab switcher user interface, or a user interface for viewing content of an open page, which includes a tab identifier (e.g., at the bottom of the UI)). For example, device 100 displays tab group switcher user interface 5022 in response to detecting tap input 5008 at tab group button 5010 in tab switcher user interface 5002 in FIG. 5A. In some embodiments, tabs are displayed in a tab bar if the tab switcher user interface is displayed (e.g., tab bar 5014 in FIG. 5A), and tab group representations are displayed in a tab group bar if the tab group switcher user interface is displayed (e.g., tab group bar 5024 in FIG. 5B). In some embodiments, the tab group bar is displayed at a same location as the tab bar. In some embodiments, tab group bar or tab bar is the same user interface region and, in response to switching from tab browsing mode to tab group browsing mode, tabs are replaced with tab group icons in the region.

In some embodiments, the plurality of tab groups are (6026) a first plurality of tab groups associated with a first browsing profile of a plurality of browsing profiles (e.g., the first browsing profile is currently active and other browsing profiles of the plurality of browsing profiles are inactive) and a second plurality of tab groups are associated with a second browsing profile different from the first browsing profile. For example, “Private,” “4 Tabs,” “Tokyo Trip,” and “Shopping” are tab groups that associated with a default system-generated browsing profile (FIGS. 5B-5G) and “Private,” “2 Tabs,” and “News,” are tab groups that are associated with a work browsing profile (FIG. 5L). In some embodiments, one or more of the first plurality of tab groups are different from one or more of the second plurality of tab groups (e.g., a first browsing profile can share a private browsing tab group with a different, second browsing profile, while all other tab groups in the first browsing profile are different from the tab groups in the second browsing profile). In some embodiments, while the first browsing profile is active, representations of a subset of the first plurality of tab groups (associated with the first browsing profile) are visible in the tab group switcher user interface (e.g., in a tab group bar) (without displaying representations of the second plurality of tab groups associated with the second browsing profile), and while the second browsing profile is active, representations of a subset of the second plurality of tab groups are visible in the tab group switcher user interface (without displaying representations of the second plurality of tab groups associated with the second browsing profile).

In some embodiments, the plurality of tab groups is (6028) a first plurality of tab groups associated with a first browsing profile of a plurality of browsing profiles (e.g., work profile, school profile, personal profile, a default profile, or other user-created or system-generated profile). The first set of representations of open pages or the second set of representations of open pages are displayed over a first background (e.g., theme, color, pattern, wallpaper, picture, or other background) associated with the first browsing profile. For example, open tabs of tab group “4 Tabs” is displayed over or overlaid onto background 5072 in FIG. 5G, and if the device 100 switches to “Tokyo Trip” tab group, the open tabs of “Tokyo Trip” tab group are also displayed over background 5072.

The computer system detects (6028) a fourth input requesting to switch from the first browsing profile to a second browsing profile (e.g., tap input 5148 in FIG. 5J optionally in combination with tap input 5162 in FIG. 5K). In response to detecting the fourth input requesting to switch from the first browsing profile to the second browsing profile, the computer system displays a different set of representations of open pages over a second background different from the first background, wherein the different set of representations of open pages is associated with a tab group of a different plurality of tab groups associated with the second browsing profile. For example, in FIG. 5L, device 100 displays open tabs 5170-5172 over background theme 5081.

In some embodiments, in conjunction with displaying the different set of representations of open pages over the second background, the computer system displays a different plurality of tab group representations that corresponds to a subset (e.g., one, two, more, or all) of the different plurality of tab groups associated the second browsing profile. For example, tab group icons 5174, 5176, 5178 are displayed in tab group bar 5024 in FIG. 5L. In some embodiments, the fourth input requesting to switch from the first browsing profile to the second browsing profile includes an input directed to a control for editing the plurality of tab groups (e.g., tap input 5098 at edit button 5100) in conjunction with other inputs directed to a control for changing a browsing profile (e.g., tap input 5142 at browsing profile icon 5140). In some embodiments, the control for editing the plurality of tab groups is displayed in a user interface for editing tab groups (e.g., user interface 5102 for editing tab groups in FIGS. 5H-5K).

In some embodiments, while displaying the plurality of tab group representations in a tab group bar, the computer system detects (6030) a fifth input (e.g., tap input 5098 in FIG. 5G). In some embodiments, the fifth input is a tap, press, or other selection input directed at a control displayed in the tab group bar (e.g., a glyph), such as tap input 5098 directed to edit button 5100 in FIG. 5G. In some embodiments, the fifth input includes a combination of selection input directed at a control displayed in the tab group bar and another selection input directed at a control displayed in a user interface for editing tab groups. For example, tap input 5098 in FIG. 5G and tap input 5082 directed at edit button 5084 in FIG. 5M. In some embodiments, the fifth input is input that meets fourth directional criteria (e.g., vertical movement, such as swipe up, where the beginning portion of the swipe up begins at a location in the tab group bar) or non-movement criteria. In some embodiments, the fourth directional criteria is different from the first and second directional criteria. In response to detecting the fifth input, the computer system displays a user interface for editing the tab groups (e.g., a tab group edit user interface, such as user interface 5102 for editing tab groups in FIGS. 5H-5K).

In some embodiments, the tab group edit user interface is displayed overlaying the tab group switcher user interface, where a portion of the tab group switcher user interface remains visible (e.g., portions of one or more representations of the first set of representations of open pages are visible). For example, user interface 5102 for editing tab groups overlays a portion of tab group switcher user interface 5022 in FIG. 5M.

In some embodiments, in the tab group edit user interface, tab groups are switched in response to a selection of respective tab group. In some embodiments, in the tab group edit user interface, browsing profiles are switched in response to a selection of respective browsing profile (using an option within the tab group edit user interface to select among a set of browsing profiles, such as options 5152, 5154 and 5156 in FIG. 5J). In some embodiments, in the tab group edit user interface, background associated with a browsing profile is switched (e.g., selected from a predefined set of backgrounds, displayed in a background selection user interface) in response to selection of a respective background for a respective browsing profile (the background for the currently selected tab group is displayed in the tab group switcher user interface shown in FIGS. 50-5P). In some embodiments, in the tab group edit user interface, a new tab group can be created (via a selection of new tab group button 5122 or new tab group button 5124 in FIG. 5H).

FIG. 7 is a flow diagram illustrating method 7000 for switching between tab groups or tabs in response to a swipe gesture, in accordance with some embodiments. Method 7000 is performed at an electronic device (e.g., device 300, FIG. 3, or portable multifunction device 100, FIG. 1A) that is in communication with a display, a touch-sensitive surface. In some embodiments, the display is a touch-screen display and the touch-sensitive surface is on or integrated with the display. In some embodiments, the display is separate from the touch-sensitive surface. Some operations in method 7000 are, optionally, combined and/or the order of some operations is, optionally, changed.

As described herein, method 7000 allows a user to efficiently navigate tab groups and tabs using a swipe gesture. Method 7000 allows a user to use the same swipe gesture directed to a tab bar in a browser application to switch between tabs and tab groups. The method switches between tabs, if tab representations are displayed in a tab bar, and between tab groups, if tab group representations are displayed in the tab bar. Using the same swipe gesture to switch between tabs and tab groups reduces the number of inputs and the amount of time necessary to navigate between tabs and tab groups in a browser application, thereby providing making the user-device interaction more efficient without cluttering the user interface of the browser application with additional controls.

In some embodiments, method 7000 is performed (7002) at a computer system (e.g., device 300, FIG. 3, or portable multifunction device 100, FIG. 1A) that is in communication with a display generation component (e.g., touch screen 112 or display 450) and one or more input devices (e.g., touch screen 112 or touch-sensitive surface 451). While displaying a user interface of a browser application, including a tab bar, the computer system detects (7004) a first input (e.g., a swipe gesture) directed to the tab bar (e.g., swipe input 5068 directed to tab group bar 5024 in FIG. 5C or swipe input 5226 directed to tab bar 5214 in FIG. 5Q). In response to detecting the first input directed to the tab bar and in accordance with a determination that a first plurality of (selectable) tab group representations are displayed in the tab bar and that the first input meets first directional criteria, wherein the first directional criteria require that the first input includes movement in a first direction in order to be met and the first plurality of (selectable) tab group representations (e.g., two or more) correspond to a first subset of a plurality of tab groups, the first subset including at least two (or three) of the plurality of tab groups (e.g., at least a private browsing tab group and a default tab group for currently open tabs), the computer system displays (7006) a second plurality of tab group representations in the tab bar (e.g., the tab group representations in the tab bar are shifted, scrolled, or otherwise navigated through), wherein the second plurality of tab group representations correspond to a second subset of a plurality of tab groups, the second subset including at least two (or three) of the tab groups (e.g., at least a private browsing tab group and a default tab group for currently open tabs).

In some embodiments, in conjunction with displaying the second plurality of tab group representations, a second set of representations of open pages replaces a first set of representations of open pages in the user interface of the browser application, where the first set of representations of open pages are associated with a first tab group of the plurality of tab groups that was active prior detecting the first input, and the second set of representations of open pages are associated with a second tab group of the plurality of tab groups that is made active in response to detecting the first input. In other words, the computer system switches from the first tab group to the second tab group in response to the first input. For example, in response to swipe input 5068 directed to tab group bar 5024 in FIG. 5C, device 100 switches from “4 Tabs” tab group to “Tokyo Trip” tab group, as shown in FIGS. 5D and 5E. Switching from “4 Tabs” tab group to “Tokyo Trip” tab group includes replacing open tabs 5050-5056 with open tabs 5076-5080 in tab group switcher user interface 5022 and/or shifting tab group icons displayed in tab group bar 5024, including ceasing display of tab group icon 5040 and displaying previously undisplayed tab group icon 5045.

In response to detecting the first input directed to the tab bar and in accordance with a determination that a first (selectable) tab representation (e.g., tab title, name, identifier, or web address of respective webpage corresponding to the first tab, or other representation of the first tab) is displayed in the tab bar and that the first input meets the first directional criteria, wherein the first tab representation corresponds to a first tab of a plurality of tabs, the computer system displays (7008) a second tab representation in the tab bar (e.g., the tab representations in the tab bar are shifted, scrolled, or otherwise navigated through) corresponding to a second tab of the plurality of tabs. In some embodiments, in conjunction with displaying the second tab representation in the tab bar, a second open page replaces a first open page in the user interface of the browser application, where the first open page is associated with the first tab and the second open page is associated with the second tab. In some embodiments, the first open page was active prior to detecting the first input, and the second page is made active in response to the first input. In other words, the computer system switches from the first tab to the second tab group in response to the first input. For example, in response to swipe input 5226 directed to tab bar 5214 in FIG. 5Q, device 100 switches from “Tokyo Hotels” tab to “Trip Advice” tab 5225. Switching from “Tokyo Hotels” tab to “Trip Advice” tab includes replacing webpage content 5220 of “Tokyo Hotels” webpage in FIG. 5Q with webpage content 5228 of “Trip Advice” webpage in FIG. 5S and/or shifting tabs 5223, 5224, and 5225 displayed in tab bar 5214, including replacing tab 5224 with tab 5225.

It should be understood that the particular order in which the operations in FIGS. 6A-6B and 7 have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 7000) are also applicable in an analogous manner to method 6000 described above with respect to FIGS. 6A-6C.

The operations described above with reference to FIGS. 6A-6C and 7 are, optionally, implemented by components depicted in FIGS. 1A-1B. For example, swipe input 5068, swipe input 5088, and swipe input 5226 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with a display generation component and one or more input devices:
while concurrently displaying a first set of representations of open pages associated with a first tab group of a plurality of tab groups of a browser application and a plurality of tab group representations corresponding to a subset of the plurality of tab groups, the subset including at least two of the tab groups:
detecting a first input directed to the plurality of tab group representations;
in response to detecting the first input directed to the plurality of tab group representations:
in accordance with a determination the first input meets first directional criteria, wherein the first directional criteria require that the first input includes movement in a first direction in order to be met, displaying a second set of representations of open pages associated with a second tab group of the plurality of tab groups.

2. The method of claim 1, wherein a private browsing mode is active in the second tab group.

3. The method of claim 1, further comprising:
in accordance with a determination the first input meets second directional criteria, wherein the second directional criteria require that the first input includes movement in a second direction in order to be met, displaying a third set of representations of open pages associated with a third tab group of the plurality of tab groups.

4. The method of claim 1, further comprising:
while displaying the second set of representations of open pages, displaying a second plurality of tab group representations corresponding to a second subset of the plurality of tab groups, and detecting a second input directed to the second plurality of tab groups representations;
in response to detecting the second input directed to the second plurality of tab group representations:
in accordance with a determination the second input meets the first directional criteria, displaying a fourth set of representations of open pages associated with a fourth tab group of the plurality of tab groups.

5. The method of claim 1, wherein the plurality of tab group representations are displayed in a tab group bar of the browser application.

6. The method of claim 1, wherein,
the first tab group is associated with a first tab group representation of the plurality of tab group representations and the second tab group is associated with a second tab group representation of the plurality of tab group representations;
prior detecting the first input, the first tab group representation is displayed at a first position, corresponding to an active tab group, and the second tab group representation is displayed at a second position adjacent to the first position; and the method includes:
in response to detecting the first input directed to the plurality of tab group representations:
displaying the second tab group representation at the first position and ceasing to display the first tab group representation at the first position.

7. The method of claim 1, wherein the plurality of tab group representations are displayed in a tab group browsing mode.

8. The method of claim 1, including:
prior to concurrently displaying the first set of representations of open pages and the plurality of tab group representations, concurrently displaying a first open page of a first set of open pages and a first tab identifier associated with the first open page, wherein the first open page corresponds to a first tab of the first tab group of the plurality of tab groups and the first tab identifier corresponds to the first tab;
detecting a second input directed to the first tab identifier associated with the open page;
in response to detecting the second input directed to the first tab identifier associated with the open page:
in accordance with a determination the second input meets the first directional criteria, wherein the first directional criteria require that the first input includes movement in the first direction in order to be met, concurrently displaying a second open page of the first set of open pages and a second tab identifier associated with the second open page, wherein the second open page corresponds to a second tab of the first tab group and the second tab identifier corresponds to the second tab.

9. The method of claim 1, wherein,
the first set of representations of open pages and the plurality of tab group representations are displayed in a user interface for switching tab groups; and
the user interface for switching tab groups is displayed in response to a third input directed to a control displayed in a user interface for switching tabs.

10. The method of claim 1, wherein the plurality of tab groups are a first plurality of tab groups associated with a first browsing profile of a plurality of browsing profiles and a second plurality of tab groups are associated with a second browsing profile different from the first browsing profile.

11. The method of claim 1, wherein,
the plurality of tab groups is a first plurality of tab groups associated with a first browsing profile of a plurality of browsing profiles;
the first set of representations of open pages or the second set of representations of open pages are displayed over a first background associated with the first browsing profile; and the method includes:
detecting a fourth input requesting to switch from the first browsing profile to a second browsing profile;
in response to detecting the fourth input requesting to switch from the first browsing profile to the second browsing profile:
displaying a different set of representations of open pages over a second background different from the first background, wherein the different set of representations of open pages is associated with a tab group of a different plurality of tab groups associated with the second browsing profile.

12. The method of claim 1, including:
while displaying the plurality of tab group representations in a tab group bar, detecting a fifth input; and
in response to detecting the fifth input, displaying a user interface for editing the tab groups.

13. An electronic device, comprising:
a display;
a touch-sensitive surface;
one or more processors; and
memory storing one or more programs, wherein the one or more programs are configured to be executed by the one or more processors, the one or more programs including instructions for:
while concurrently displaying a first set of representations of open pages associated with a first tab group of a plurality of tab groups of a browser application and a plurality of tab group representations corresponding to a subset of the plurality of tab groups, the subset including at least two of the tab groups:
detecting a first input directed to the plurality of tab group representations;
in response to detecting the first input directed to the plurality of tab group representations:
in accordance with a determination the first input meets first directional criteria, wherein the first directional criteria require that the first input includes movement in a first direction in order to be met, displaying a second set of representations of open pages associated with a second tab group of the plurality of tab groups.

14. The electronic device of claim 13, wherein a private browsing mode is active in the second tab group.

15. The electronic device of claim 13, wherein the one or more instructions include instructions for:
in accordance with a determination the first input meets second directional criteria, wherein the second directional criteria require that the first input includes movement in a second direction in order to be met, displaying a third set of representations of open pages associated with a third tab group of the plurality of tab groups.

16. The electronic device of claim 13, wherein the one or more instructions include instructions for:
while displaying the second set of representations of open pages, displaying a second plurality of tab group representations corresponding to a second subset of the plurality of tab groups, and detecting a second input directed to the second plurality of tab groups representations;
in response to detecting the second input directed to the second plurality of tab group representations:
in accordance with a determination the second input meets the first directional criteria, displaying a fourth set of representations of open pages associated with a fourth tab group of the plurality of tab groups.

17. The electronic device of claim 13, wherein the plurality of tab group representations are displayed in a tab group bar of the browser application.

18. The electronic device of claim 13, wherein,
the first tab group is associated with a first tab group representation of the plurality of tab group representations and the second tab group is associated with a second tab group representation of the plurality of tab group representations;
prior detecting the first input, the first tab group representation is displayed at a first position, corresponding to an active tab group, and the second tab group representation is displayed at a second position adjacent to the first position; and
wherein the one or more instructions include instructions for:
in response to detecting the first input directed to the plurality of tab group representations:
displaying the second tab group representation at the first position and ceasing to display the first tab group representation at the first position.

19. The electronic device of claim 13, wherein the plurality of tab group representations are displayed in a tab group browsing mode.

20. A computer readable storage medium storing one or more programs, the one or more programs comprising instructions that, when executed by an electronic device that is in communication with a display generation component cause the electronic device to:
while concurrently displaying a first set of representations of open pages associated with a first tab group of a plurality of tab groups of a browser application and a plurality of tab group representations corresponding to a subset of the plurality of tab groups, the subset including at least two of the tab groups:
detect a first input directed to the plurality of tab group representations;
in response to detecting the first input directed to the plurality of tab group representations:
in accordance with a determination the first input meets first directional criteria, wherein the first directional criteria require that the first input includes movement in a first direction in order to be met, display a second set of representations of open pages associated with a second tab group of the plurality of tab groups.
